(19) United States
(12) Patent Application Publication
(10) Pub. No.: US 2024/0319348 A1
(43) Pub. Date: Sep. 26, 2024

(54) TIME-OF-FLIGHT CAMERA SYSTEM

(71) Applicant: Analog Devices International Unlimited Company, Limerick (IE)

(72) Inventors: Jonathan Ephraim David Hurwitz, Edinburgh (GB); Davide Portaluppi, Wakefield, MA (US); Edward Chapin Guthrie, Charlestown, MA (US)

(21) Appl. No.: 18/126,255

(22) Filed: Mar. 24, 2023

(51) Int. Cl. G01S 7/497; G01S 17/894

(52) U.S. Cl. CPC G01S 7/497; G01S 17/894

(57) ABSTRACT

The present disclosure provides an improved time-of-flight (ToF) system. The ToF system includes a light source, a main image and a plurality of secondary image sensors. A controller is configured to determine an error of the ToF system based on charge accumulated by the plurality of secondary image sensors. The controller may be configured to determine a ToF distance measurement using the main image sensor. The error determined using the plurality of secondary image sensors may be used to correct the ToF distance measurement, improving the accuracy of the ToF system.

### TECHNICAL FIELD

The present disclosure relates to a time-of-flight (ToF) system, and in particular a ToF system configured to determine at least one of a cyclic error and an offset error. The present disclosure further relates to a method for determining at least one of a cyclic error and an offset error.

### BACKGROUND

Time-of-flight (ToF) camera systems are range imaging systems that resolve the distance between the camera and an object by measuring the round trip of light emitted from the ToF camera system and reflected by the object. The systems typically comprise a light source (such as a laser or LED), a light source driver to control the emission of light from the light source, an image sensor to image light reflected by the object, an image sensor driver to control the operation of the image sensor, optics to shape the light emitted from the light source and to focus light reflected by the object onto the image sensor, and a computation unit configured to determine the distance to the object based on the emitted light and the corresponding light reflection from the object.

In a Continuous Wave (CW) ToF camera system (also known as an indirect ToF system), multiple periods of a modulated light are emitted from the laser. The system is then configured to determine the distance to the imaged object based on a phase difference between the emitted light and the received reflected light. CW ToF systems often modulate the emitted laser light at a first modulation frequency and determine a first phase difference between the emitted light and reflected light, before modulating the emitted laser light at a second frequency and determining a further phase difference between the emitted light and reflected light. A depth map/depth frame can then be determined based on the first and second phase differences. The first frequency and second frequency are different so that the first and second phase differences can be used to resolve phase wrapping. Alternatively, in some continuous wave systems, only a single frequency is used.

### SUMMARY

The present inventors have recognised that there is need for improved correction of cyclic and offset errors.

In a first aspect, there is provided a time-of-flight, ToF, imaging system, the ToF imaging system comprising: a light source; an image sensor; and a controller coupled to the light source and the image sensor, wherein the controller is configured to: control the light source to emit modulated light using a modulated control signal; determine, based on charge accumulated by the image sensor, an error of the ToF system, wherein the error comprises at least one of a cyclic error and an offset error; and modify the light emitted from the light source to reduce the error of the ToF system.

The controller may be configured to modify the light emitted from the light source by adjusting a timing of the modulated control signal relative to a charge accumulation control signal used to control the image sensor.

The controller may be configured to modify the light emitted from the light source by pre-distorting the modulated control signal.

Pre-distorting the modulated control signal may comprise one or more of: adjusting a duty cycle of the modulated control signal; controlling the light source to emit light using a first modulated control signal for a first period of time and controlling the light source to emit light using a second modulated control signal for a second period of time; adjusting a shape of the modulated control signal.

The ToF system may comprise a light source driver configured to receive the modulated control signal, generate a drive signal based on the modulated control signal and drive the light source to emit light using the drive signal, wherein the controller is configured to modify the light emitted from the light source by adjusting at least one setting of the light source driver so as to adjust the drive signal generated by the light source driver.

At least one setting of the light source driver may comprise one or more of: sag compensation; over/under shoot; up-sampled arbitrary waveform generation; and analog component adjustment.

The ToF imaging system may further comprise a controllable delay circuit in a signal path of the modulated control signal, wherein the controllable delay block is configured to receive the modulated control signal and delay transmission of the modulated control signal to the light source, and wherein the controller is configured to modify the light emitted from the light source by setting the length of the delay applied by the controllable delay block.

The controller may be configured to iteratively modify the light emitted from the light source until the error of the ToF system is reduced.

The ToF system may further comprise an internal optical path for carrying part of the modulated light emitted from the light source to at least part of the imaging sensor, wherein the controller is configured to determine the error of the ToF system based on the charge accumulated by the imaging sensor as a result of light carried from the light source to the imaging sensor by the internal optical path.

The imaging sensor may comprise a primary image sensor area for receiving light for use in determining a ToF image; and a secondary image sensor for receiving light from the internal optical path, wherein the controller is configured to determine the error of the ToF system based on the charge accumulated by the secondary image sensor.

In a second aspect there is provided a method of operating a time-of-flight (ToF) system, the method comprising: emitting light from at least one light source; detecting light emitted from the at least one light source on a secondary image sensor; determining one or more of an offset andr cyclic error present in the ToF system based on the light detected at the secondary image sensor; compensating for one or more of the offset and cyclic error determined by modifying a signal input to the at least one light source.

The method may further comprise supplying a first modulated control signal and a second modulated control signal to the light source.

The method may further comprise modifying one or more of: a timing, phase offset and duty cycle of the first modulated control signal and the second modulated control signal to compensate for one or more of the cyclic and offset error of the ToF system.

The method may further comprise iteratively modifying one or more of the first modulated control signal and the second modulated control signal until one or more of the cyclic and offset error determined by the processor is reduced.

The method may further comprise modifying a controllable delay in the signal path of the first light source to compensate for the determined offset error.

The method may further comprise determining a distance to an object based on light incident on a primary image sensor.

In a third aspect, there is provided a time-of-flight (ToF) system, the ToF system comprising: a light emission unit comprising: at least one light source configured to emit light; at least one secondary image sensor; an optical path of a known distance between the at least one light source and the at least one secondary image sensor; a processor configured to determine offset and/or cyclic errors of the ToF system based on an output of the secondary image sensor, the processor further configured to alter a control signal input to the light emission unit to compensate for the offset and/or cyclic errors of the ToF system.

The processor may be configured to iteratively adjust the control signal input to the light emission unit until one or more of the determined offset and cyclic error is reduced.

The ToF system may further comprise a primary image sensor.

The ToF system may use multiple secondary image sensors or secondary feedback arrays.

According to a fourth aspect, there is provided a time-of-flight (ToF) imaging system, the ToF system comprising: a light source for outputting modulated light; a main image sensor; a plurality of secondary image sensors; an internal optical path of a known distance for carrying part of the modulated light emitted from the light source to each of the plurality of secondary image sensors; and a controller configured to determine, based on charge accumulated by the plurality of secondary image sensors, an error of the ToF system, wherein the error comprises at least one of a cyclic error and an offset error.

The controller may be configured to control the light source to emit the modulated light for a first amount of time using a first laser modulation signal.

The controller may be configured to control the charge accumulation of the plurality of secondary image sensors during the first amount of time such that each image sensor of the plurality of secondary image sensors is configured to accumulate charge over a different phase range of the first laser modulation signal.

The controller may be configured to control the light source to emit light for a second amount of time using a second laser modulation signal.

The second laser modulation signal may be a delayed version of the first laser modulation signal.

The second laser modulation signal may be the same as the first laser modulation signal.

The controller may be configured to control the charge accumulation of the plurality of secondary image sensors during the second amount of time such that each image sensor of the plurality of secondary image sensors is configured to accumulate charge over a different phase range of the second laser modulation signal.

The controller may be configured to determine a phase relationship between modulated light emitted by the light source and light received by the plurality of secondary image sensors.

The controller may be configured to determine the error of the ToF system by comparing the determined phase relationship with a theoretical phase relationship based on the known distance of the internal optical path.

The plurality of secondary image sensors may comprise four image sensors.

The controller may be configured to perform a ToF distance measurement by detecting light incident on the first imaging sensor.

The controller may be configured to correct the ToF measurement using the determined error of the ToF system to reduce the error of the ToF system.

The controller may be configured to use the determined error of the ToF system to modify the light outputted from the light source to reduce the error of the ToF system.

According to a fifth aspect, there is provided a method of determining distance using a time of flight (ToF) system, the method comprising: emitting modulated light using a light source; detecting the emitted light at a main image sensor; detecting the emitted light at a plurality of secondary image sensors located a known distance from the at least one light source; determining at least one of an offset and a cyclic error of the ToF system based on charge accumulated by the plurality of secondary image sensors.

The method may further comprise controlling charge accumulation of the plurality of secondary image sensors during a first time period such that each image sensor of the plurality of secondary image sensors is configured to accumulate charge over a phase range of the emitted light different to that of the other image sensors of the plurality of secondary image sensors.

The method may further comprise controlling charge accumulation of the plurality of image sensors during a second time period such that each image sensor of the plurality of images sensors is configured to accumulate charge over a phase range of the emitted light different to that of the other image sensors of the plurality of secondary image sensors and different to the phase range during the first time period.

Determining at least one of an offset and cyclic error may comprise determining a phase relationship between the emitted modulated light and light received by the plurality of secondary image sensors; and comparing a determined phase relationship with a theoretical phase relationship based on the known distance.

The method may further comprise applying a calibration to the ToF system based on the determined at least one of offset and cyclic error.

The method may further comprise determining a ToF distance measurement based on the light detected at the main image sensor.

According to a sixth aspect, there is provided a time-of-flight (ToF) imaging system, the ToF system comprising: a light source configured to emit light; a plurality of secondary image sensors; an optical path of a known distance between the at least one light source and the plurality of secondary image sensors, arranged such that part of the emitted light is carried by the optical path to the plurality of secondary image sensors; and a controller configured to: control the plurality of secondary image sensors, such that each image sensor of the plurality of secondary image sensors accumulates charge over a different phase range of the emitted light; and determine at least one of a phase error and an offset error, using charge accumulated by each of the plurality of secondary image sensors.

The ToF system may utilise a secondary array to perform further functions.

According to a seventh aspect, there is provided a time-of-flight, ToF, imaging system, the ToF system comprising: a first light source for emitting first light; a first image sensor; a second image sensor; an internal optical path for carrying part of the first light from the first light source to the second image sensor; and a controller configured to perform a ToF measurement by detecting light incident on the first imaging sensor

The controller may be configured to determine a characteristic of the light received at the second image sensor.

The characteristic may comprise one or more of an instantaneous intensity of the light, a measure of the intensity of light received over a period of time, an amplitude of the light, a linearity of the light.

The controller may be configured to compare the characteristic of the light received at the second image sensor with a threshold range; operate a safety function if the characteristic of light is outside the threshold range.

The system may further comprise an optical control switch located in the internal optical path between the first light source and the second image sensor, wherein the optical control switch is controllable to allow or prevent transmission of light along the internal optical path.

The controller may be configured to control the optical control switch to allow transmission along the optical path during a period in which the controller is performing an operation which uses light detected at the second image sensor.

The controller may be configured to control the optical control switch to prevent transmission along the optical path during a period in which the controller is performing an operation which does not use light detected at the second image sensor.

The ToF system may further comprise a second light source.

The controller may be configured to determine at least one of an offset error and a cyclic error of the first light source; and determine at least one of an offset error and a cyclic error of the second light source.

The ToF system may further comprise a controllable delay in a signal path of the first light source or the second light source, and wherein the controllable delay is configured to compensate a difference between the offset error of the first light source and the second light source.

The second image sensor may be part of the first image sensor.

The internal optical path may comprise an optical guide configured to direct part of the emitted first light from the first light source to the second image sensor. The optical guide may comprise one or more of: an optical fiber; a mirror; a lens; a refractive element.

The controller may be configured to determine at least one of a cyclic error and offset error, based on charge accumulated by the second image sensor as a result of the light carried from the first light source to the second image sensor by the internal optical path.

According to an eight aspect, there is provided a method of controlling a time-of-flight imaging system, the method comprising: emitting first light from a first light source; performing a ToF measurement based on detecting light incident on a first image sensor; detecting light incident on a second image sensor, the light detected on the second image sensor having travelled down an optical path of a known distance from the first light source.

The method may further comprise determining a characteristic of the light incident on the second image sensor; and comparing the characteristic of the light incident on the second image sensor to a threshold range to determine whether the first light source is operating within a predetermined operating range.

The method may further comprise controlling an optical switch in the optical path between the first light source and the second image sensor, the optical switch capable of preventing light transmission between the first light source and the second image sensor.

According to a ninth aspect, there is provided, a time-of-flight, ToF, imaging system, the ToF system comprising: a light emission unit comprising at least one light source; a first image sensor; an optical guide configured to direct light along an optical path of a known distance between the at least one light source and the first image sensor; an optical switch, located in the optical path between the at least one light source and the first image sensor, wherein the optical switch is configurable to allow or prevent light transmission down the optical path between the at least one light source and the first image sensor; and a controller configured to: control the optical switch to allow light transmission along the optical path; and determine at least one of a cyclic error and an offset error of the ToF imaging system based on detecting light incident on the first image sensor.

When the controller is not determining the cyclic error or offset error, the controller may be configured to control the optical switch to prevent light transmission along the optical path.

The controller may be configured to perform a time-of-flight measurement using light incident on the first imaging sensor, wherein when the controller is performing a time-of-flight measurement, the optical switch is controlled to prevent light transmission along the optical path.

### BRIEF DESCRIPTION OF THE DRAWINGS

FIG. 1 shows a continuous wave ToF camera system;

FIG. 2 is a diagram relating to the phases of operation of the ToF camera system of FIG. 1;

FIGS. 3a and 3b show the relationship between the ideal or inserted phase of a ToF system and the detected phase;

FIG. 4 shows a ToF system including a secondary image array;

FIG. 5 shows a ToF system including means for controlling light;

FIG. 6 shows a ToF system including multiple light sources;

FIG. 7 shows a ToF system including an optical path which includes an optical switch;

FIG. 8 shows a ToF system with a single optical array and an optical path which includes an optical switch;

FIG. 9 shows a ToF system with a plurality of secondary image arrays;

FIG. 10 is a diagram relating to the phases of operation of the ToF system of FIG. 9;

FIG. 11 is a diagram relating to the phases of operation of the ToF system of FIG. 9;

FIG. 12 is a diagram of the relationship between ideal and inserted phase for the phases of operation of FIG. 11;

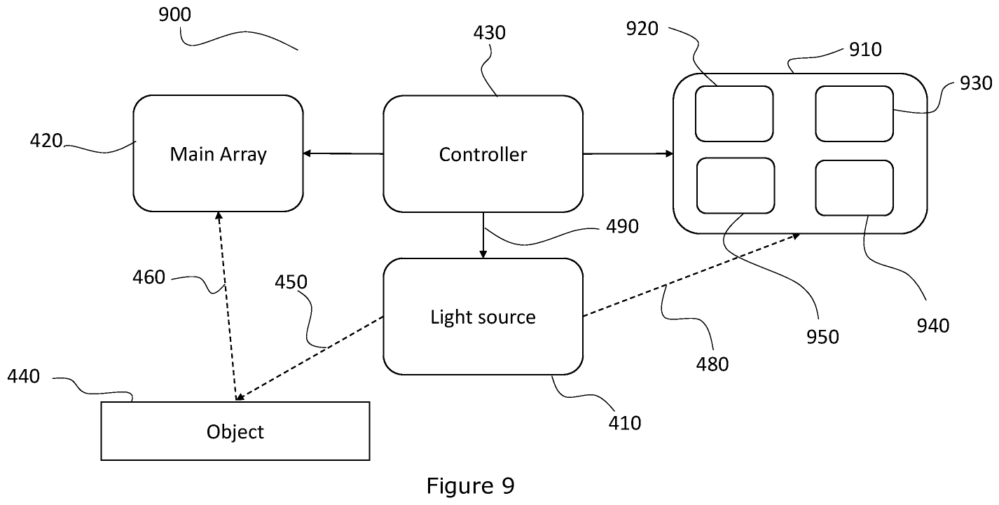

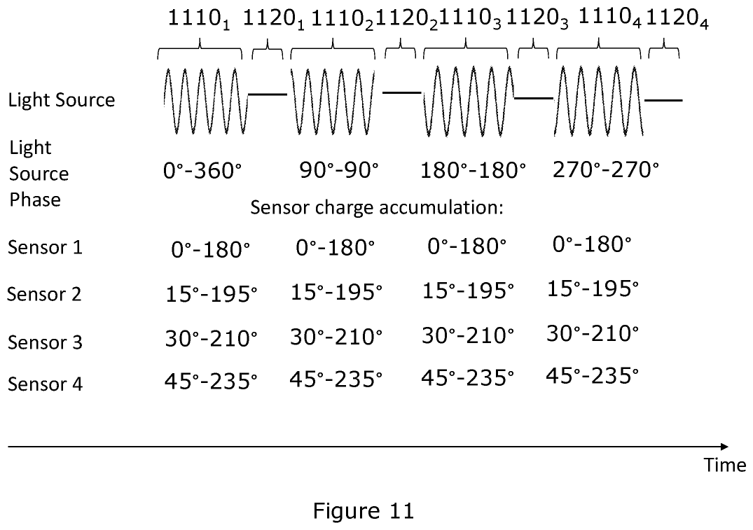

FIG. 11a is a diagram relating to alternative phases of operation of the ToF system of FIG. 9;

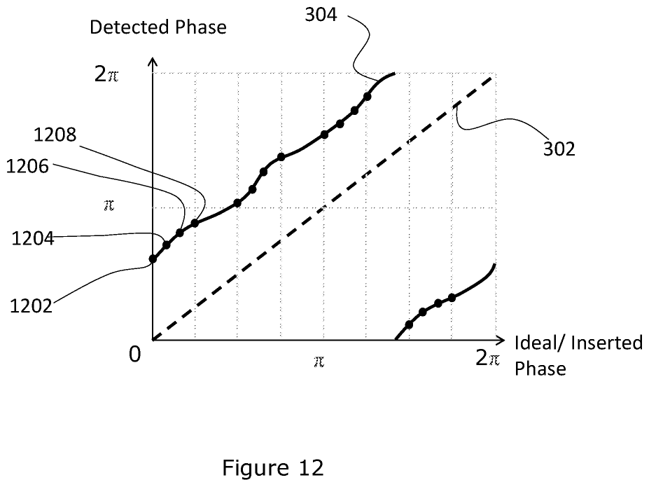

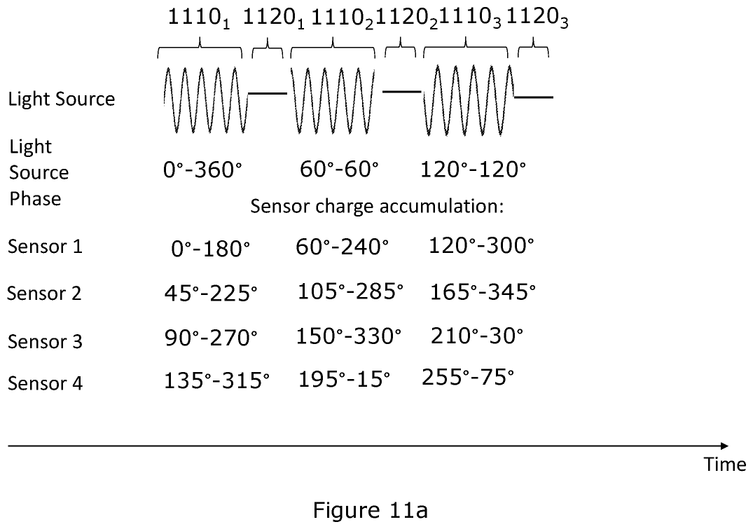

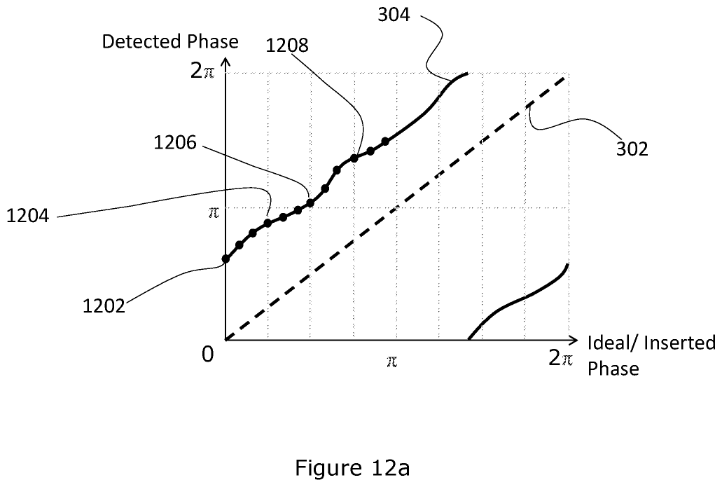

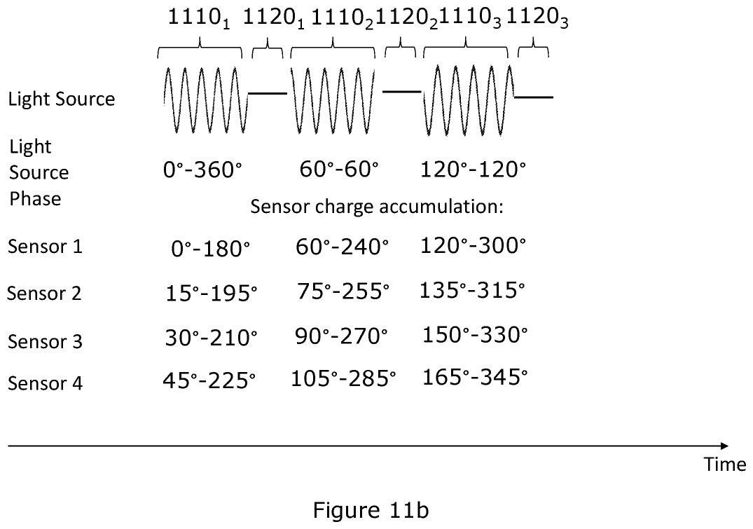

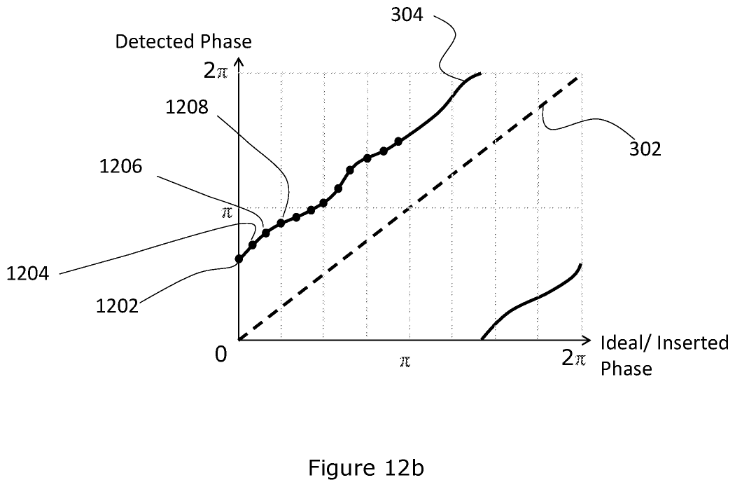

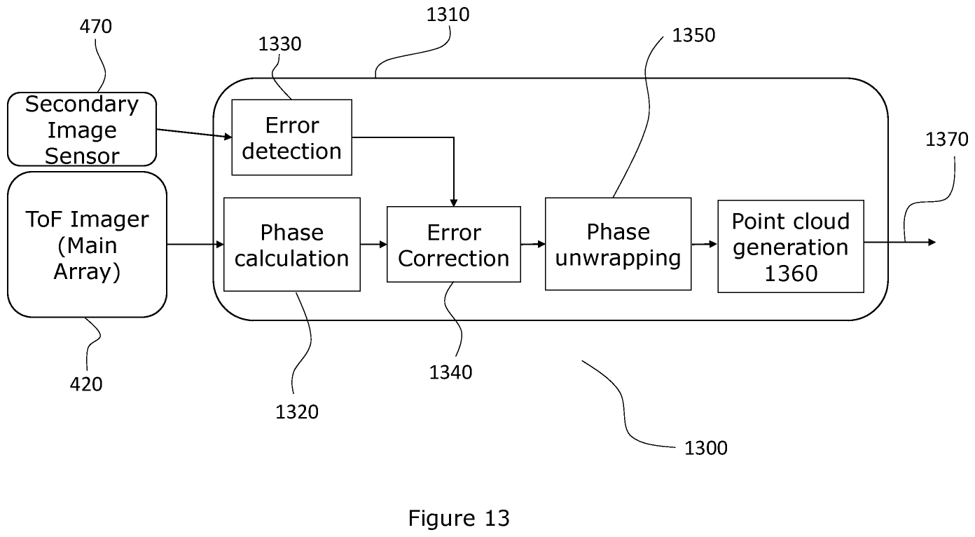

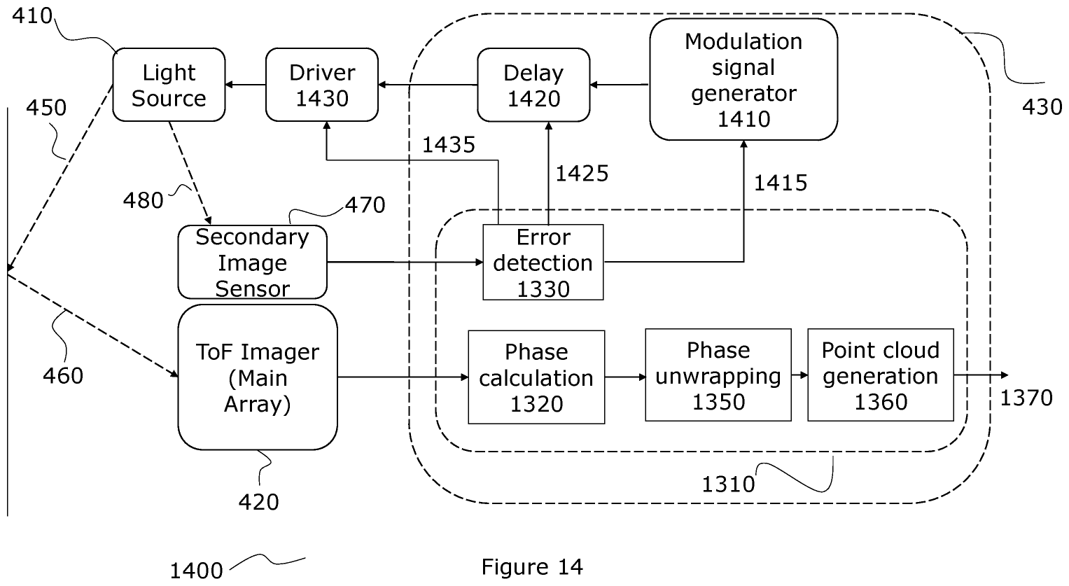

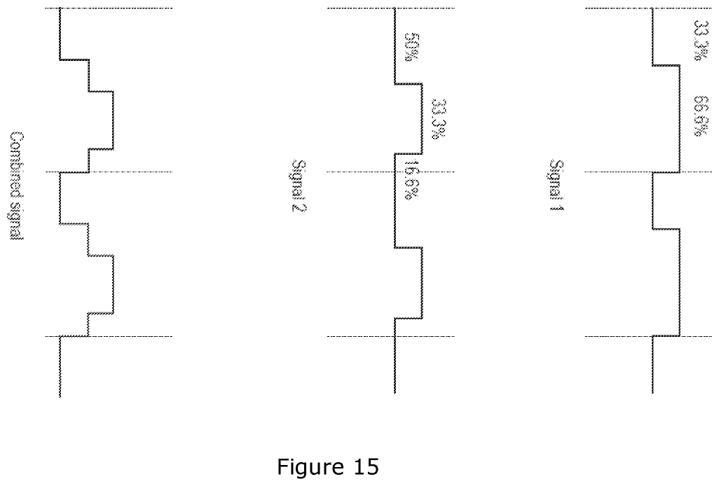

FIG. 12a is a diagram of the relationship between ideal and inserted phase for the phases of operation of FIG. 11a;

FIG. 11b is a diagram relating to alternative phases of operation of the ToF system of FIG. 9;

FIG. 12b is a diagram of the relationship between ideal and inserted phase for the phases of operation of FIG. 11b;

FIG. 13 shows a ToF system including error detection;

FIG. 14 shows a ToF system including error compensation;

FIG. 15 shows one way in which the modulation signal of a ToF system may be modified to reduce the impact of harmonics.

### DETAILED DESCRIPTION

A CW ToF camera system uses an image sensor to determine the phase shift between emitted and detected light. This phase shift may be used to determine the distance travelled by the emitted light. However, cyclic and offset errors may be present in CW ToF systems, lowering the accuracy of the determined distance measurement. To address this issue, the inventors have developed various different ways in which a secondary image sensor may be used to determine the cyclic and/or offset errors. The use of a second imaging sensor for error determination may allow a number of further features to be implemented. For example, the second image sensor may allow for monitoring of the safety of the optical system and/or, where multiple light sources are used, allow the detection and correction of a skew between the light sources. Further, the inventors have determined a number of ways in which the determined offset and cyclic errors may be compensated.

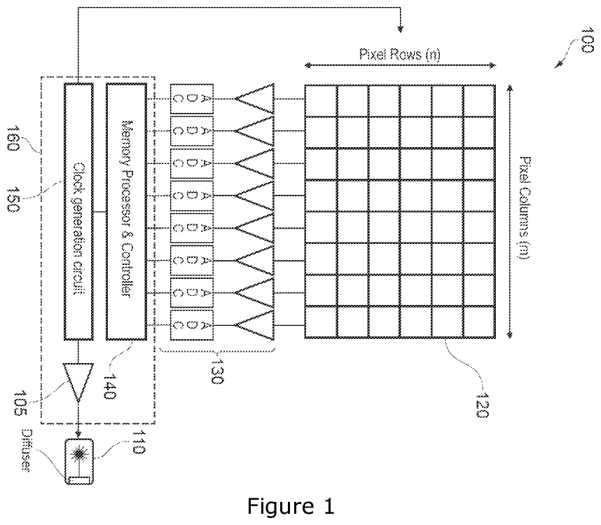

FIG. 1 shows an example representation of a CW ToF camera system 100. The system 100 comprises a laser 110 (which may be any suitable type of laser) and a laser driver 105 configured to drive the laser 110 into light emission.

The system 100 also comprises an imaging sensor 120 that comprises a plurality (in this case m×n) of imaging pixels. The imaging pixels can be at least one of various demodulating types. A converter system 130 (comprising a plurality of amplifiers and ADCs) is coupled to the imaging sensor 120 for reading off charge accumulated on the imaging pixels and converting to digital values, which are output to the memory processor & controller 140. The nature of the values read out from the imaging sensor 120 will depend on the technology of the imaging sensor 120. For example, if the imaging sensor is a CMOS sensor, voltage values may be readout, where each voltage value is dependent on the charge accumulated in an imaging pixel of the imaging sensor 120, such that the readout values are each indicative of charge accumulated in imaging pixels of the imaging sensor 120. In other sensor technologies, the nature of the readout values may be different, for example charge may be directly readout, or current, etc. The memory processor & controller 140 is configured to determine depth frames (also referred to as depth maps), indicative of distance to the object being imaged, based on the received digital values indicative of charge accumulated on the imaging pixels. The memory processor & controller 140 may also be configured to determine active brightness frames (also referred to as 2D IR frames/images). The memory processor & controller 140 controls a clock generation circuit 150, which outputs timing signals for driving the laser 110 and for controlling the imaging sensor 120. The converter system 130, memory processor & controller 140 and clock generation circuit 150 may together be referred to as an image acquisition system, configured to determine one or more depth frames by controlling the laser 110 and image sensor 120, reading off the image sensor 120 and processing the resultant data.

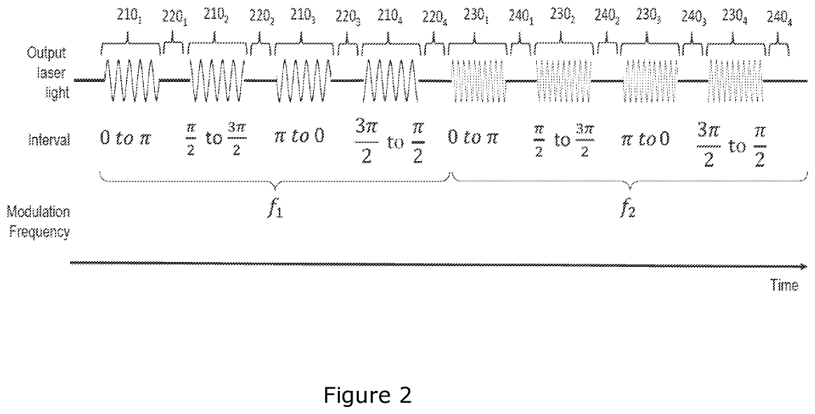

FIG. 2 shows an example schematic diagram to help explain the operation of the system 100. The memory processor & controller 140 and clock generation circuit 150 control the laser 110 to output first laser light modulated by a first modulation signal having a first frequency f₁ for an accumulation period of time 210₁. During this period of time, some of the first laser light reflected from the object will be incident on the imaging sensor 120. During the accumulation period of time 210₁, the memory processor & controller 140 and clock generation circuit 150 also controls the imaging sensor 120 to accumulate charge based on the incident reflected first laser light for the first part/interval of the period/cycle of the first laser light (0° to 180°, or 0 to π). For example, the imaging sensor 120 is controlled to “open its shutter” for charge accumulation at the times when the phase of the emitted first laser light is between 0° to 180°. This is so that the phase of the received first laser light relative to the emitted first laser light at a first interval of 0 to π may later be determined using the charge accumulated on the imaging sensor 120, for example by cross correlating the accumulated charge signal with the first modulation signal. In this example, accumulation takes place for half of the period/cycle of the first laser light, but may alternatively take place for any other suitable amount of time, for example for one quarter of the phase of the first laser light. The skilled person will readily understand how to control the accumulation timing of the imaging sensor 120 using control signals based on the timing of the laser modulation signal. As will be understood by the skilled person, if the image sensor 120 is a single ended pixel type, the pixels may be controlled to accumulate charge for this part/interval of the period and not accumulate any charge for the remainder of the period. If the image sensor 120 is a differential pixel type, the pixels may be controlled to accumulate charge for this part/interval of the period on one side of the pixel and accumulate charge on the other side of the pixel for the remainder of the period. For example, such a pixel could be 2-tap de-modulating pixels that accumulate charge in the respective taps relating to the high periods of two signals representing phase-a and phase-b of the clock that is provided to it. It can be noted that the pixel can have a higher number of taps and take in more signals, for example 4-tap pixels would have 4 signals each with a signal with a high period equating to a different 90 degrees of the 360 degrees of the demodulating frequency being used. This also applies to the other accumulation parts/intervals described later.

During a subsequent read out period of time 2201, the memory processor & controller 140 and clock generation circuit 150 control the first laser 110₁ to cease emitting light and control the imaging sensor 120 to readout image sensor values that are indicative of the charge accumulated in the imaging pixels of the imaging sensor 120. The nature of the readout values will depend on the technology of the imaging sensor 120. For example, if the imaging sensor 120 is a CMOS sensor, voltage values may be readout, where each voltage value is dependent on the charge accumulated in an imaging pixel of the imaging sensor 120, such that the readout values are each indicative of charge accumulated in imaging pixels of the imaging sensor 120. In other sensor technologies, the nature of the readout values may be different, for example charge may be directly readout, or current, etc. For example, the imaging sensor 120 may be controlled to readout image sensor values row-by-row using any standard readout process and circuitry well understood by the skilled person. In this way, a sample of charge accumulated by each imaging pixel during the period 210₁ may be read off the imaging sensor 120, converted to a digital value and then stored by the memory processor & controller 140. The group of values, or data points, arrived at the conclusion of this process is referred to in this disclosure as a charge sample.

It will be appreciated that the accumulation period of time 210₁ may last for multiple periods/cycles of the first modulation signal (as can be seen in FIG. 1) in order to accumulate sufficient reflected light to perform an accurate determination of the phase of the received reflected light relative to the first modulation signal, for the interval 0 to π of the first modulation signal.

During accumulation period of time 210₂, the memory processor & controller 140 and clock generation circuit 150 again control the first laser 110₁ to output first laser light modulated by the first modulation signal for an accumulation period of time 210₂. This is very similar to the accumulation period 210₁, except during accumulation period of time 210₂ the memory processor & controller 140 and clock generation circuit 150 controls the imaging sensor 120 to accumulate charge for the second part/interval of the period/cycle of the first modulation signal (90° to 270°, or π/2 to 3π/2). The read-out period 220₂ is very similar to period 220₁, except the obtained charge sample relates to a shifted or delayed interval of π/2 to 3π/2 of the first modulation signal.

Accumulation period of time 210₃ is very similar to the period 210₂, except the memory processor & controller 140 and clock generation circuit 150 controls the imaging sensor 120 to accumulate charge for the third part/interval of the period/cycle of the first modulation signal (180° to 360°, or π to 2π). The read-out period 220₃ is very similar to period 220₂, except the sampled charge data relates to a shifted or delayed interval of π to 2π of the first modulation signal.

Finally, accumulation period of time 210₄ is very similar to the period 210₃, except the memory processor & controller 140 and clock generation circuit 150 also controls the imaging sensor 120 to accumulate charge based on the incident reflected first laser light for a fourth part/interval of the period/cycle of the first modulation signal (270° to 90°, or 3π/2 to π/2). The read-out period 220₄ is very similar to period 220₃, except the charge sample relates to a shifted or delayed interval of 3π/2 to π/2 (or, put another, a shifted or delayed interval of 3π/2 to 5π/2).

It can be seen from the above that for each accumulation period 210₁-210₄, the start timing of pixel accumulation timing relative to the laser modulation signal is shifted (i.e., the relative phase of the laser modulation signal and the pixel demodulation signal, which controls pixel accumulation timing, is shifted). This may be achieved either by adjusting the pixel demodulation signal or by adjusting the laser modulation signal. For example, the timing of the two signals may be set by a clock and for each of the accumulation periods 210₁-210₄, either the laser modulation signal or the pixel demodulation signal may be incrementally delayed by π/2.

Whilst in this example each accumulation period 210₁-210₄ lasts for 50% of the period of the laser modulation signal (i.e., for 180º), in an alternative each accumulation period may be shorter, for example 60°, or 90°, or 120°, etc, with the start of each accumulation period relatively offset by 90° as explained above.

After completing this, four samples of data (charge samples) have been acquired and stored in memory. They together may be referred to as a first set of charge samples. Immediately after the read out period 220₄, or at some later time, a phase relationship between the first laser light and the received reflected light may be determined using the four charge samples (for example by performing a discrete Fourier transform (DFT) on the samples to find the real and imaginary parts of the fundamental frequency, and then determining the phase from the real and imaginary parts, as will be well understood by the skilled person). This may be performed by the image acquisition system, or the charge samples may be output from the image acquisition system to an external processor via a data bus for the determination of the phase relationship. Optionally, active brightness (2D IR) may also be determined (either by the image acquisition system or the external processor) for the reflected first laser light using the four samples (for example, by determining the magnitude of the fundamental frequency from the real and imaginary parts, as will be well understood by the skilled person).

The skilled person will readily understand that using DFT to determine the phase relationship between the first laser light and the received reflected laser light, and to determine active brightness, is merely one example and that any other suitable alternative technique may be used. By way of brief explanation a further non-limiting example is now described.

The transmitted, modulated laser signal may be described by the following equation:

$$s ( t ) = {A}_{s} sin ( 2 π ft ) + {B}_{s}$$

Where:
s(t)=optical power of emitted signal
f=laser modulation frequency
Aₛ=amplitude of the modulated emitted signal
Bₛ=offset of the modulated emitted signal

The signal received at the imaging sensor may be described by the following equation:

$$r ( t ) = α ( {A}_{s} sin ( 2 π ft + Φ ) + {B}_{s} ) + {B}_{e n v}$$

$$Φ = 2 π f Δ$$

$$Δ = \frac{2 d}{c}$$

Where:
r(t)=optical power of received signal
α=attenuation factor of the received signal
Φ=phase shift
Bₑₙᵥ=amplitude of background light
Δ=time delay between emitted and received signals (i.e., time of flight)
d=distance to imaged object
c=speed of light

Accumulation timing of the imaging pixels may be controlled using a demodulation signal, g(t−τ), which is effectively a time delayed version of the illumination signal.

$$g ( t - τ ) = {A}_{g} sin ( 2 π f ( t - τ ) ) + {B}_{g}$$

Where:
τ=a variable delay, which can be set to achieve the phase delays/offsets between each accumulation period 210₁-210₄ described above
A_{g}=amplitude of the demodulation signal
B_{g}=offset of the demodulation signal

The imaging pixels of the imaging sensor 120 effectively multiply the signals r(t) and g(t−τ). The resulting signal may be integrated by the imaging pixels of the imaging sensor to yield a cross correlation signal c(τ):

$$c ( τ ) = A sin ( 2 π f ( t - τ ) ) + B$$

By driving the imaging sensor to accumulate at different phase offsets during different accumulation periods, as described above, it is possible to measure correlation at different time offsets τ (phase-offsets φ) 0, π/2, π, 3π/2:

$$c ( τ ) = A sin ( 2 π f ( t - τ ) ) + B = A sin ( Φ - φ ) + B$$

$$c ( τ ) = A ( sin ( Φ ) cos ( - φ ) + cos ( Φ ) sin ( - φ ) ) + B$$

$$c ( 0 ) = A 1 = A ( sin ( Φ ) ) + B$$

$$c ( \frac{π}{2} ) = A 2 = - A ( cos ( Φ ) ) + B$$

$$c ( π ) = A 3 = - A ( sin ( Φ ) ) + B$$

$$c ( \frac{3 π}{2} ) = A 4 = A ( cos ( Φ ) ) + B$$

From these readings, it can be determined that the phase offset/time of flight can be found by:

$$Φ = 2 π f Δ = arctan ( \frac{sin ( Φ )}{cos ( Φ )} ) = atan ( \frac{A 1 - A 3}{A 4 - A 2} )$$

Therefore, a depth image or map can be determined using the four charge samples acquired from the image sensor.

An active brightness, or 2D IR, image/frame may also be determined by determining \sqrt{(A4−A2)²+(A1−A3)²}.

Subsequently, the process described earlier in relation to periods 210₁-210₄ and 220₁-220₄ may then be repeated in accumulation periods 230₁-230₄ and read out periods 240₁-240₄. These are the same as the accumulation periods 210₁-210₄ and read out periods 220₁-220₄, except rather than driving the laser 110 to emit light modulated with the first modulation signal, the laser 110 is driven to emit light modulated with a second modulation signal. The second modulation signal has a second frequency f₂, which is higher than the first frequency f₁. As a result, four further samples of data (charge samples) are obtained and stored in memory. Based on these charge samples, a phase relationship between the second laser light and the received reflected light (and optionally also the active brightness for the reflected second laser light) may be determined either by the image acquisition system or the external processor, for example using DFT or correlation function processes as described above.

Using the determined phase relationship between the first laser light and the received reflected light and the determined phase relationship between the second laser light and the received reflected light, phase unwrapping may be performed and a single depth image/frame determined by the memory processor & controller 140 (as will be understood by the skilled person). In this way, any phase wrapping issues can be resolved so that an accurate depth frame can be determined. This process may be repeated many times in order to generate a time series of depth frames, which may together form a video.

Optionally, a 2D IR frame may also be determined using the determined active brightness for the first laser light and the determined active brightness for the second laser light.

In this example, there are four accumulation periods for each laser modulation frequency, each accumulation period being at a different phase offset relative to the laser modulation signal. This may be referred to as four times oversampling. However, in a different example there may be a different number of accumulation periods per frequency, such as two, three, six, eight, etc. Typically, larger numbers of different accumulation periods (each at a different phase offset relative to the laser drive signal) reduces the number of harmonics that fold back into the fundamental frequency (as will be understood from Nyquist sampling theory), which in turn reduces noise. This is briefly explained below.

Whilst FIG. 2 represents the laser light modulation signal as a sinusoidal (sine) signal, it may alternatively be a square wave signal.

To determine the distance to an object, CW ToF systems rely on the phase relationship between the emitted/transmitted laser light and the received reflected light. However, delays are present within the timing of the ToF system. These delays may include process, voltage and temperature (PVT) delays which occur in different parts of the system, for example, in the memory processor & control 140, in the clock generation circuit 150 and in the laser driver 105, among other parts of the system. These errors may vary due to variance in the temperature of the ToF system and its environment, variance in the supply voltage and the process variance between different ToF systems.

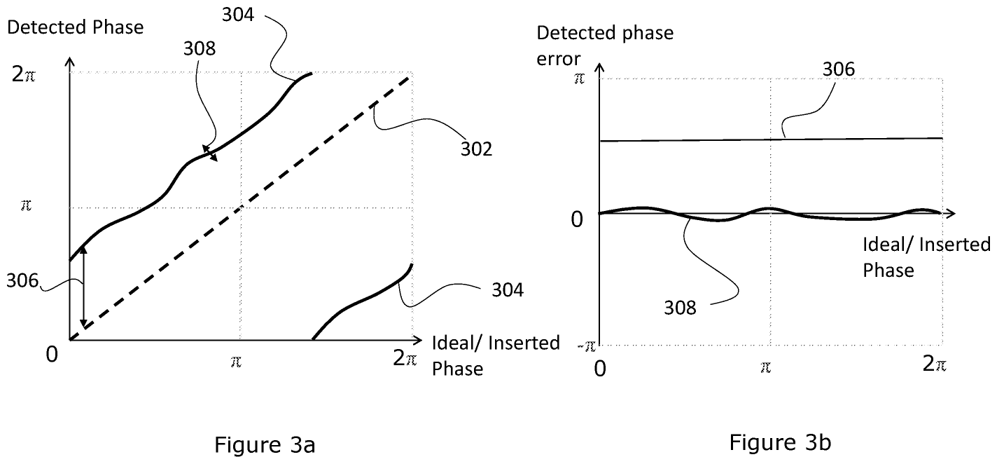

Delay or error between the assumed laser light transmission and the actual laser light transmission may cause an error in the detected distance to an object. FIG. 3a shows an example of a phase relationship between the inserted phase/delay and the actual or detected phase/delay in a ToF system. The ideal or inserted phase may represent the phase difference expected between the emitted and received laser light over a set distance. The detected phase may represent the phase difference between the transmitted/emitted and received laser light which is actually measured by the system. In an ideal case, the ideal/theoretical and the detected phase difference are the same, as represented by line 302. In these conditions, the distance may be measured accurately as the phase difference between the transmitted and received laser light is detected accurately.

However, the phase difference between the emitted and reflected light may not align with the ideal situation represented by line 302, due to both cyclic and offset errors. For example, line 304 may represent a measured phase difference which includes offset error 306 and cyclic error 308. Offset error 306 is a constant phase error between the ideal and measured phase differences, resulting in a constant distance error when the distance to the object under measurement is calculated. Cyclic error, for example the variance shown by reference numeral 308, results in a varying or oscillating error on the detected phase measurement.

FIG. 3b shows a representation of the ideal/inserted phase against the size of the error in the detected phase, where the offset error 306 and the cyclic error 308 have been separated. As can be seen, the offset error is constant over the phase range, whereas the cyclic error varies.

Cyclic errors may be introduced through harmonics in the laser modulation. For example, some systems may use square-waves to drive the laser, due to the lower complexity and cost of generating square waves compared to the generation of sinusoidal waves. A perfect sinusoid includes a frequency component only at the fundamental frequency, whereas square waves also include further harmonic frequency components. Other sources of harmonics can be the VCSEL response to the electrical signal driving it, or non linearities in the pixels demodulating characteristics. Removing cyclic errors introduced by square-wave laser driving can allow the system to use a square wave drive signal instead of a sinusoid, reducing the computational and power cost of generating the drive signals. Driving with a square wave also for a given maximum current creates a larger fundamental frequency component than a sine wave of the same magnitude, but at the expense of harmonics which contribute to the cyclic errors.

The offset error may be introduced by fixed delays in the timing of drive/control signals within the ToF system. In one example, there may be a delay between the timing of the laser drive signal and timing of when light is actually emitted from the laser, for example by virtue of the time it takes for the modulated laser drive signal to reach the laser driver 105, be processed by the laser driver 105, reach the laser 110 and then excite light to be emitted from the laser 110. Some systems may have more than one laser with more than one driver and control signal, which may vary independently. This is often done to increase the illumination power which helps the TOF system work over wider angles and/or distances

To provide accurate distance measurement, both the cyclic error and the offset error may be reduced or removed during the process of determining a depth frame/image using the data readout from the imaging sensor. This first requires calibration of the ToF system to determine the cyclic and offset errors. Calibration is typically performed on a device-by-device basis in the factory, but this is this is both costly-requiring further manufacturing time—and challenging. Further, the delays or error in the ToF system may drift over time or over temperature, resulting in a system whose accuracy reduces or varies over time or temperature. The effect with temperature may be reduced by having a learnt change in response with temperature, and a measurement of temperature and combining them to perform a correction. For practical reasons the change in response with temperature is characterised on a number of units and then applied to all, to avoid per unit cross temperature testing, but here the variation between a given unit and the characterised unit with temperature will also lead to an error.

It is therefore required to provide an improved system of reducing or removing these errors in the phase measurement.

### Second Imaging Sensor

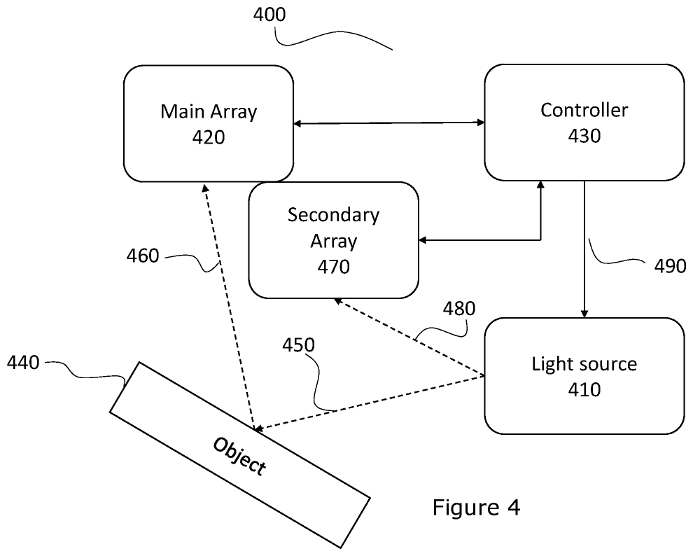

FIG. 4 shows a ToF system 400, including a primary/main/first array or imaging sensor 420. The ToF system operates in a similar manner to that described with respect to FIGS. 1 and 2, in that a controller 430 controls a light emission unit 410, which comprises a light source such as a laser. Light emission unit 410 may be supplied with a modulated control signal 490, which may be processed by one or more drivers within the light emission unit in order to drive the light source to emit light. A first part 450 of light emitted from the light emission unit 410 may reflect 460 off an object 440 in the environment and be detected by the main array 420. The phase shift between the light emitted by the laser 410 and the light received by the main array 420 may then be used to determine the distance travelled by the light 450 between the laser 410 and the object 440, as described with respect to FIG. 2.

The system 400 further includes a secondary/second array or imaging sensor 470. The secondary array 470 is positioned such that there is an optical path 480 between the light emission unit 410 and the secondary array 470, the optical path 480 being internal to the system 400. The optical path 480 is a known, constant, distance, such that light emitted by the laser 410 travels over a known distance before it is received by the secondary array 470. The optical path 480 may, for example, comprise fibre optics and/or one or more mirrors and/or one or more prisms, and is configured such that a part (typically a relatively small part) of the light emitted from the light emission unit 410 enters the optical path 480 and is guided to the secondary array 470. The optical path may be largely through free space, or through material that partially attenuates such as moulded black but still allows some part of the light to reach the secondary array. The remainder (typically a relatively large part) of the light emitted from the light emission unit 410 forms the emitted light 450 This emitted light may go through a diffuser array or other optical component such as dot projector or diffractive optics, mirror and/or refractive lens on the way to the scene/object 440. The light fed to the local optical path 480 may be taken from reflected or scattered light from any of these elements. The relative optical light power in the path 480 is proportional to the optical power of the emitted light 450 and largely static in relationship. The effective distance of the coupled light from the laser to the secondary array along the optical path 480 can be considered largely constant although temperature or drift may change it very slightly. In cases where there are multiple light emission units 410, multiple optical paths 480 could be used to feedback to one or more secondary arrays 470.

Whilst the system shown in FIG. 4 includes a controller 430 separate to the main array 420, in some systems the controller 430 may be included as part of the main array 420, in an “imager” package. Further, the system 400 may include a depth processor separate to the controller 430 to determine the distance travelled by the light between the laser 410 and the object 440 (for example, determining depth frames, as described earlier with reference to FIGS. 1 and 2) and/or to determine any offset or cyclic errors in the system 400. Alternatively, one or both of those functions may be performed by the controller 430.

As the secondary array 470 is a known optical distance from the light emission unit 410, the theoretical phase shift that should occur between the emitted light and the received light is a known quantity which may be calculated. However, due to offset and cyclic errors, the actual measured phase difference between the emitted light and the light received at the secondary array 470 will not be the same as this theoretical phase shift. Therefore, by measuring the phase shift which occurs between the emitted light and the light received at the secondary array 470, and comparing this measured value to the previously calculated theoretical value, an offset and cyclic error for the system may be calculated.

For example, the phase shift between the emitted light and light received at the secondary array 470 may be calculated using the method described with respect to FIG. 2, by acquiring a number of charge samples using a number of accumulation periods, where the timing of pixel accumulation relative to the laser modulation signal 490 is different for each accumulation period.

As the cyclic error 308 varies over the ideal/inserted phase difference (equivalent to a variance over distance travelled), the system 400 may need to acquire charge samples across the phase range. This is achieved by varying the relative timing of the accumulation period of the secondary array 470 and the modulated control signal 490, such that samples are taken by the secondary array 470 at different phase offsets, for example, at 0°, 90°, 180° and 270°, as shown in FIG. 2. In this way, a measured phase relationship between the laser light and the received reflected light may be determined using the charge samples readout from the secondary array 470 (for example by performing a discrete Fourier transform (DFT) on the samples to find the real and imaginary parts of the fundamental frequency, and then determining the phase from the real and imaginary parts, as will be well understood by the skilled person). There are other ways to calculate the measured phase versus the theoretical phase. These are not described here for reasons of brevity only.

Taking a greater number of charge samples at different phase relationships compared to the fundamental frequency of the modulated control signal 490 allows the detection of cyclic errors caused by a greater number of harmonics, introduced by, for example, square wave laser driving. By detecting the cyclic errors more accurately, it may be possible to reduce them more effectively with compensation. To acquire a number of different charge samples each at different phase offsets as described earlier with reference to FIG. 2, the phase relationship between the modulated control signal 490 and the accumulation control signal of the secondary array 470 (eg, the demodulation signal driving the secondary array 470) be modified by the controller 430 by adjusting the relative timing of the modulated control signal 490 and the accumulation control signal of the secondary array 470.

Once the system 400 offset and cyclic errors are determined using the data readout from the secondary array 470, compensation may be applied (as explained in more detail below) so as to reduce the errors and improve the accuracy of depth frames determined using the main array 420.

### Internal Optical Feedback

The internal optical feedback path 480 between the light source 410 and the secondary array 470 should have a known optical distance. To achieve this, a form of optical guide between the laser 410 and the secondary array 470 may be provided. For example, an optical fiber, mirror, lens or refractive/diffractive element may be positioned between the laser 410 and the secondary array 470 to guide to the secondary array 470 a portion of the light emitted from the laser 410.

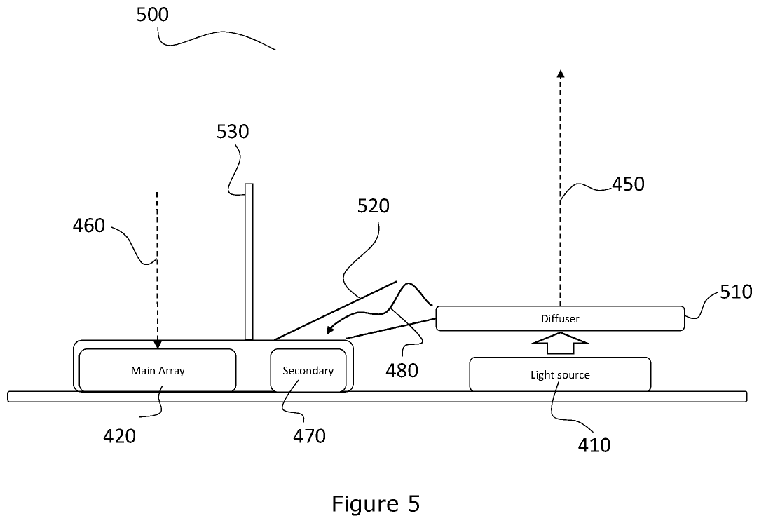

FIG. 5 shows an example representation of a ToF system 500, including a light source 410, main array 420 and secondary array 470. A diffuser 510 may be located in the light emission path of the light source 410 to diffuse the emitted light. An optical guide 520 may direct a portion 480 of the light to the secondary array 470. The optical guide may include a fiber, mirror, lens or refractive/defractive element to guide a portion 480 of the light to the secondary array 470.

In some instances, light 480 which is routed to the secondary array 470 may also be detected at the main array 420 due to scattering or spreading of the light 480. This light is not reflected from objects, and therefore provides no useful information to the main array 420 relating to distance/depth determination of objects and may instead reduce the accuracy of distance/depth determinations. It may therefore be beneficial to reduce the reception of light 480 at the main array 420. With this in mind, optionally a blocking element 530 may be positioned between the main array 420 and the secondary array 470 to reduce the proportion of light 480 directed at the secondary array 470 which reaches the main array 420. Where the main array 420 and the secondary array 470 are co-located on the same chip, the main and secondary arrays may be located on different parts of the chip so that there is space to position the blocking element 530 between them. It will be appreciated that the blocking element 530 is optional and may be omitted entirely, for example where the physical arrangement of the main and secondary arrays and/or the optical guide 520 are such that there is no problem, or potential for, any part of the light 480 being incident on the secondary array 470.

Further, the light 480 directed at the secondary array 470 may be of a lower intensity than the light 450 used for imaging the environment. For example, the optical guide 520 may be positioned so that the portion of light 480 routed to the secondary array 470 is at least an order of magnitude smaller than the light 450 directed into the wider environment for distance or object detection. For example, the portion of light 480 routed to the secondary array 470 may be 1/10^{th}, 1/100^{th}, 1/1000^{th}, 1/10000^{th} or less than 1/100000^{th} of the total light produced by the light source 410, such that even if some of the portion of light 480 scatters or spreads and reaches the main array 420, it is likely to be of a significantly lower intensity than the light 460 which has reflected off objects in the environment. Furthermore, by redirecting only a relatively small amount of the emitted light to the secondary array 470, the intensity of light 450 can be kept high, which may be of benefit for ToF imaging.

Whilst FIG. 5 shows a diffuser 510 above a VCSEL array 410, the system could optionally, or alternatively, include edge emitters, lenses, and/or steering optical in the laser path 450.

### Optional Features of a Second Imaging Sensor

A secondary array or secondary image sensor 470 arranged to receive light that has been internally fed-back may optionally provide further features to a ToF system which would not otherwise be possible. In these situations, the secondary array 470 may provide the additional features as well as or instead of determination of the offset and/or cyclic errors.

### Secondary Array for Safety

ToF systems are often used in safety-critical applications. For example, in vehicles, ToF may be used to provide an auto-brake function when a pedestrian is detected, or to prevent collisions with other vehicles. If the ToF system malfunctions, and there is no or limited knowledge that the system has malfunctioned, decisions may be made based on erroneous distance measurements. This may result in safety-critical decisions being made on the basis of erroneous data.

The secondary array 470 of the present system may optionally be useful for monitoring further characteristics of the light source 410, such as the phase response, amplitude, luminance, light intensity and/or the linearity of the laser response. For example, the controller may be configured to monitor the amount or intensity of light received at the secondary array 470 in order to monitor the performance of the light source 410. The measured response of the system while operating can be compared with one of a batch characterised response of a number of similar units, an expected response from modelling or simulation, or a measured response of the unit when it was initially manufactured and tested, or a definition in one or more of the parameters of offset distortion. Intensity or output power above or below an acceptable amount, for example intensity which is greater than a threshold or less than a threshold, can be used to flag a pending or actual issue in the system.

During object detection using the main array 420, the secondary array 470 should receive a known amount of light from the laser 410 along optical path 520. If the amount of light received at the secondary array 470 is outside of normal range, the system may halt or stop operation of the ToF system, or provide reduced assurances as to the accuracy of the distance measured by the ToF system (for example by flagging that any output depth/distance frames may have a reduced accuracy). This may ensure that the level of laser light transmitted is within safe bounds. Too much light emitted by the laser 410 may damage the eyes of people within range, whereas too little may result in objects being undetected, or detected with lower accuracy, due to the lower illumination of the scene. Further, in a situation where the light directed at the secondary array 480 is guided using an optical waveguide 520 which is integrated with the diffuser 510, too little light may indicate that the diffuser 510 has become displaced which is an eye safety issue. Too much light could also indicate a change such as the laser driver power supply had increased or the diffuser was displaced in a way such as to couple more light, but a significant change would still be indicative of a likely failure.

The system may compare the measured characteristic of light with a predetermined operating range or threshold range. As described above, the threshold range may relate to acceptable operating parameters outside of which the system does not operate in a satisfactory manner. For example, the threshold range may define a range in which eye damage does not occur, but which still allows accurate detection of objects. Based on this, the secondary array 470 may provide feedback to a diagnostic or safety system as to whether the system should shut down or alter operation.

The system may monitor the absolute light intensity received at the secondary 470 image sensor. Alternatively, the system may monitor the intensity of light received over a period of time. Where there is a deviation in the intensity of the received light outside of the normal intensity of received light, the system may activate a safety function of the ToF system, for example turning off the ToF system. The normal range of operation of the light source 410 may be determined on a device-by-device basis during factory calibration, with numerical limits being stored in memory in the system (not represented in the figures) for use during operation of the ToF system. The relationship of the expected proportion of light coupled to the secondary array 470 relative to the amount of light emitted to the scene 410 may be factored in. A normal range of operation may be known from the specification of the light source 410, design of the optical guide 520 and the secondary array 470, such that a predetermined normal range of operation may be stored in memory without requiring device by device calibration.

### Secondary Array for Calibration of Multiple Lasers

In industrial settings and applications, ToF systems may be operated using multiple light sources to increase the illumination available, providing improved accuracy of depth determination. In some systems, the light sources may be operated with the same control signals, such that the lasers are operated in sync.

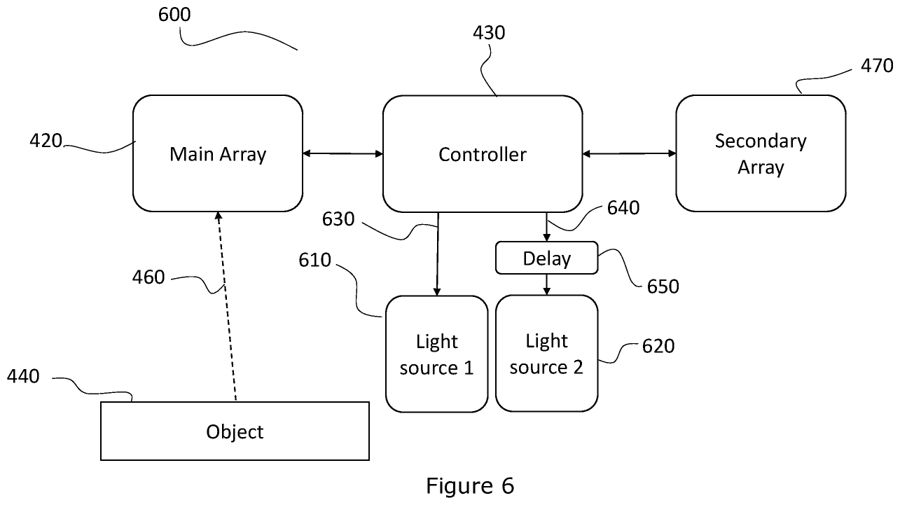

FIG. 6 shows an example of a ToF system 600 which includes a first light source or laser 610 and a second light source or laser 620. The first light source 610 may be driven by a first modulation signal 630 and the second light source 620 may be driven by a second modulation signal 640. The first modulation signal 630 and the second modulation signal 640 may control the light sources in the same way, such that the light sources are modulated to emit light at the same modulation frequency and in-phase.

However, differences in light sources themselves, and/or the control paths and circuitry of the first and second light sources, and/or other PVT errors, may cause the light output from the two light sources to differ. For example, the light they emit may have different offset and/or cyclic errors. Imaging the same scene with two lasers with different offset and cyclic errors may result in an error in the distance measurements which in the past has been very difficult to correct as the contribution of each light source cannot easily be separated.

The internal optical feedback arrangements of the present disclosure may be used to address this issue. In particular, the process described above with respect to determining the offset and cyclic errors of a single light source may be applied to a system with two or more light sources, such that the relative offset and cyclic errors of each light source are determined. For example, optical guides maybe used to internally feedback a portion of the light emitted from light source 1 610 to the secondary array 470 and internally feedback a portion of the light emitted from light source 2 620 to the secondary array 470. During error determination, the controller 430 may be configured to operate just light source 1 610, then determine offset and/or cyclic errors of that light source using the secondary array 470. Subsequently, the controller 430 may operate just light source 2 620, then determine the offset and/or cyclic errors of that light source using the secondary array 470. In an alternative, a separate secondary array may be provided for each light source, such that both light sources may be operated concurrently during error determination, which may enable error determination to take place at the same time as depth/distance determination using the main array 420. Optionally, the optical feedback path for each light source may be completely different, or at least part of the optical feedback path for light emitted from the first and second light sources may be shared.

The system 600 may include a variable or controllable delay 650 in the control signal path of light source 2 620. Once the offset errors of the two light sources have been determined as explained above, the controller 430 may set the time delay applied by the delay block 650 such that relative offset errors between light emitted from the two light sources is reduced or removed. In an alternative, the delay unit 650 may be positioned to delay modulation signal 630, or a delay unit may be positioned in the modulation signal path for each light source. In the latter example, the controller 430 may be configured to achieve the same, predetermined overall offset for both light sources, such that once the offset error of each light source has been determined, an appropriate delay is added to the modulation signal for each light source so that both light sources have the same total offset. Instead of using a delay 620 in the path of one of the light sources, alternative means for calibrating the first 610 and second 620 light sources may be used to insert an effective phase delay.

Whilst FIG. 6 shows a system with two lasers or light sources 610, 620, the above example may also be applied to a system with more than two light sources, for example, three, four, five or more light sources. In a system with more than two light sources, a controllable delay block may be included in the modulation signal path of all the light sources, or all but one of the light sources.

Secondary Array with Optical Control

Optionally, an optical control switch 720 may be included in the internal optical path between the light source 410 and the secondary array 470.

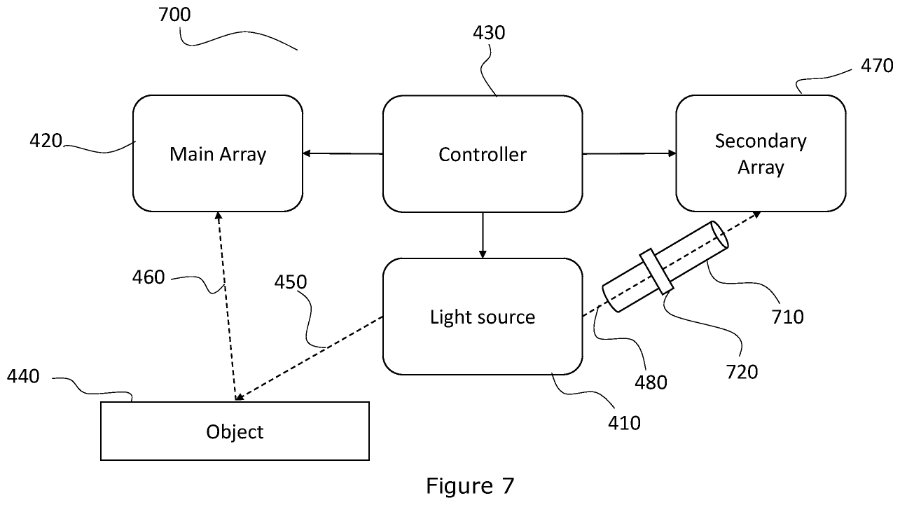

FIG. 7 shows a ToF system 700 which includes an optical guide 710 between the light source 410 and the secondary array 470 to guide a portion of the transmitted light to the secondary array 470. An optical switch 720 is provided in the optical path, allowing transmission of the light from the light source 410 to the secondary array 470 to be controlled, for example allowing the route through the optical guide 710 to be opened or closed. In this way, internal optical feedback of light to the secondary array 470 may be turned on and off, for example by the controller 430.

In some implementations, light which is internally fed-back to the secondary array 470 may inadvertently be detected by the main array 420 due to scattering or spreading of the light. In this case the optical switch 720 may be configurable such that the light path between the laser 410 and the secondary array 470 to be turned off when not in use for any specific function, for example, when not being used to determine safe operation of the laser, or when not being used to determine offset and cyclic errors.

Offset and cyclic errors may be measured and calculated intermittently or periodically, for example, hourly, daily, weekly or monthly, or every time the ToF system starts up. When the offset and cyclic errors are not being measured, the optical switch 720 may be engaged to prevent light being internally fed back to the secondary array 470, thereby reducing the potential for light to scatter and be detected at the main array 420. This reduces the incidence of multipath light detection by the main array 420, ensuring that each object is illuminated solely, or principally, by the main light path 450 when the secondary array 470 is not in use. Furthermore, when there are two or more light sources, as described above with reference to FIG. 6, an independent optical switch may be included in the optical feedback path for each light source. This enables internal feedback of light from only one light source at a time, meaning that all light sources may continue to emit light (enabling distance/depth operations using the main array 420 to continue) whilst also performing error measurements for each light source, one at a time, using the secondary array 470.

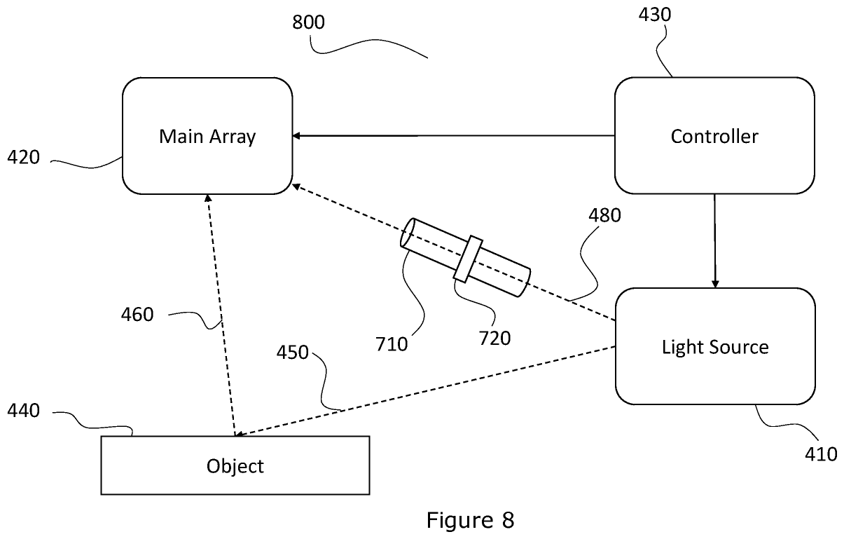

FIG. 8 shows a further example ToF system 800 in accordance with an aspect of the disclosure. The system 800 includes a single imaging sensor—the main or first array 420. As well as performing distance detection based on light 460 which reflects off objects in the environment, the main array 420 may be used to provide periodic cyclic and offset error determination. An optical guide 710 directs a portion 480 of the light emitted from the light source 410 to the main array 420. The optical guide 710 includes an optical switch 720 which may be used to selectively control light passage through the optical guide.

Periodically, the main array 420 may be used to determine the cyclic and offset errors present in the ToF system 800 using light directed through optical guide 710. During error determination, external light 460 may be blocked from illuminating the main array 420 (for example, by virtue of a controllable shutter, not represented in the figure) and the optical switch 720 may be controlled to allow the light 480 to pass to the main array 420. When the system 800 is operating in normal distance/depth determination mode, external light 460 may be allowed to illuminate the main array 420 and the optical switch 720 may be controlled to prevent light travelling down the optical guide 710. With the use of such periodic or intermittent optical control, the main array 420 may at times be used for offset/cyclic error determination, safety functions and/or or calibration of multiple lasers, as described in the various examples above.

Where the main array 420 is used to provide the function of the secondary array 470, a sub-part of the main array may be used. For example, the optical guide 710 may direct light along an optical path onto only a part of the main array 420. Alternatively, internally fed-back light 480 may illuminate the whole of the main array 420.

Using the main array 420 to perform the secondary array functions described above may help to reduce the size of the ToF system, as a secondary array is not required.

### Multiple Secondary Arrays

To determine the offset and cyclic error of the system, a number of samples are taken using the secondary image sensor at different phases, by adjusting the relative phase of the light source modulation signal and the accumulation control signal of the secondary array (also referred to as the demodulation signal used to control the secondary array). When determining cyclic error, a greater number of samples may increase the accuracy of the determination, for example by detecting the effects of higher order harmonics. However, an increased number of samples takes a longer period of time when compared to taking a smaller number of samples. There is therefore a trade-off between the time taken to determine the cyclic error and the accuracy of the determination. Faster acquisition can be useful in systems that are used periodically. In periodic systems, changes in the ambient conditions in between uses mean that the offset and cyclic errors may have changed between the last time of operation and the current time of operation. Accurate operation is important from as soon as the system is used, and therefore fast acquisition of cyclic errors is important. Faster acquisition can also help track changes.

FIG. 2 shows a representation of accumulation and readout periods in the context of depth/distance determination. However, it is useful also for understanding the operation of the secondary array in the process of determining cyclic and offset error using a secondary array 470. For example, where there is a single secondary array, the main array 420 and the secondary array 470 may be controlled using the same accumulation control signal output by the controller 430. In this case, for the example of FIG. 2, the secondary array 470 may be controlled to operate in four intervals or accumulation periods 210₁, 210₂, 210₃, and 210₄ consecutively. For each of these accumulation periods, the secondary array is controlled to accumulate charge over a different phase interval of the modulated laser light: 0−π, π/2−3π/2, π−0 (or 2π) and 3π/2−π/2 (or 5π/2) respectively. These accumulation periods may also be referred to as 0, π/2, π and 3π/2 respectively. After each accumulation period, the samples are readout during the readout periods 220₁-220₄. This is then repeated at the second frequency f2. As a result, the amount of time required to acquire the samples from the secondary array 470 is quite long. Furthermore, in this example the number of different phase samples that can be acquired from the secondary array 470 is limited to the same number of different phase samples that the main array 420 acquires. As noted with respect to FIG. 2, these accumulation periods are examples, and other phases/period lengths may be used.

It may be possible to increase the number of different phase samples from the secondary array 470 compared with the main array 420 by controlling the two arrays with different accumulation control signals. However, this may increase the complexity of control, since the controller 430 would need to be configured to output two independent array control signals with different amounts of phase offset relative to the modulated light signal. Furthermore, increasing the number of different phase samples acquired by the secondary array 470 will further increase the time taken to perform offset and cyclic error determination.

In view of this, the inventors have developed an implementation that includes a plurality of secondary imaging sensors/arrays (e.g., two or more secondary imaging sensors/arrays).

FIG. 9 shows a ToF system 900 where the plurality of secondary image arrays 910 comprises four image sensors. For the sake of simplicity of language, these will be referred to from hereon as internal feedback arrays, since each of them are configured to received internally fed-back light from the light source 410. In this example, there are four internal feedback arrays: a first internal feedback array 920, a second internal feedback array 930, a third internal feedback array 940 and a fourth internal feedback array 950. Although four have been shown in FIG. 9, any number of internal feedback arrays may be used, for example, 2, 3, 4, 5, 6, 7, 8, 12, 16, etc. Each internal feedback array may comprise any number of pixels and may be implemented as sub-parts of the same image sensor, or as separate image sensors within the ToF system 900.

Each internal feedback array 920, 930, 940, 950 may be controlled using a separate accumulation control signal, such that the timing of accumulation for each array may be different, or skewed, relative to each other. Put another way, each internal feedback array may be controlled to “open its shutter” for charge accumulation at different relative phases, for a different phase range, of the light modulation signal. However, a single accumulation control signal may still be output by the controller 430 for controlling the plurality of secondary arrays 910 (which may also be the same accumulation control signal used for the main array 420). In this case, each internal feedback array 920-950 may be configured to apply a different delay to the received accumulation control signal, such that the actual accumulation timing of each internal feedback array 920-950 may be different to each other.

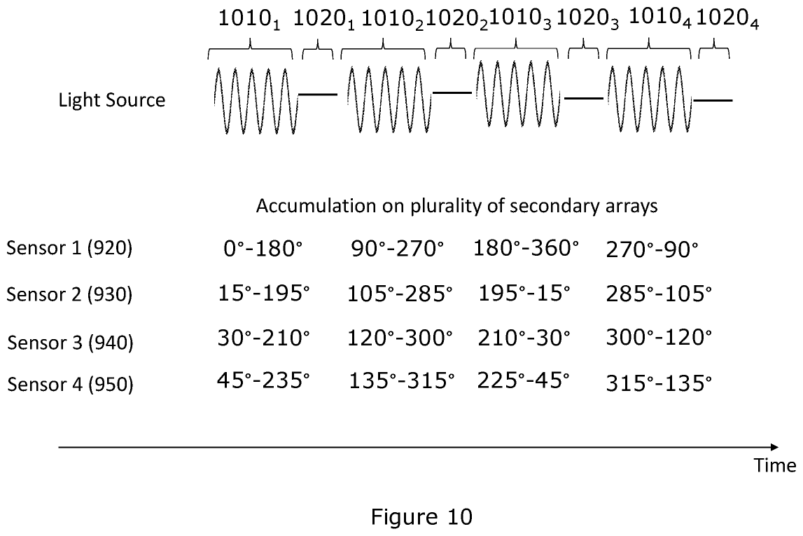

FIG. 10 shows an example diagram to help explain the operation of the system 900 which includes four internal feedback arrays. The controller 930 controls the light source 910 to output first laser light modulated by a first modulation signal having a first frequency f₁ for an accumulation period of time 1010₁. During this period of time, a portion of the first laser light is internally fed-back to the plurality of secondary image sensors 910. During the accumulation period of time 1010₁, controller 430 may control the plurality of secondary arrays 910 to accumulate charge from internally fed-back light 480. In one example, a single accumulation control signal may be output by the controller 430 to the plurality of secondary arrays 910, which each internal feedback array 920-950 applying a different delay to that control signal. For example, for the first accumulation period 1010₁, the accumulation control signal may instruct the image sensors to “open their shutter” to accumulate charge between 0° to 180° of the light modulation signal. The first internal feedback array 920 may not apply any delay to that signal, such that the first internal feedback array 920 accumulates charge between 0° to 180° of the light modulation signal. The second internal feedback array 930 may apply a delay to the accumulation control signal, for example one that equates to a 15° phase delay. In this example, during the first accumulation period 1010₁, the second internal feedback array 930 would accumulate charge between 15°-195° of the light modulation signal. The third internal feedback array 940 may apply a different delay to the accumulation control signal, for example one that equates to a 30° phase delay. In this example, during the first accumulation period 1010₁, the third internal feedback array 940 would accumulate charge between 30°-210° of the light modulation signal. The fourth internal feedback array 950 may apply a further different delay to the accumulation control signal, for example one that equates to a 45° phase delay. In this example, during the first accumulation period 1010₁, the fourth internal feedback array 950 would accumulate charge between 45°-235° of the light modulation signal.

Another way to generate the relative phases is to have multiple control lines coming from the controller 430 that might output the control lines from multiple stages within a DLL or PLL that may already be present for generating the relative phase between the control signal for the main array and the light source.

The relative delays do not need to be evenly spread—as long as they are relatively well known they can be accommodated for in the calculation of offset and cyclic error.

The plurality of second arrays may be implemented as different columns of pixels abutting each other but which are driven by the different control signals. The secondary light (480) being feedback may have a slightly different path length to the different sub arrays and this may also be accommodated for in the calculation. There can also be multiple sub arrays at nominally the same delay, that are inter digitated in some way as to minimise this source of error.

By operating the plurality of secondary arrays 910 in this manner, the phase of light received at the secondary arrays 910 relative to the light emitted from the light source 410 over the intervals noted above may be determined using the charge accumulated on the plurality of secondary arrays 910, for example by cross correlating the accumulated charge signals with the modulation signal 490. In this example, each accumulation interval for the plurality of secondary arrays 910 spans half of the period/cycle of the light source modulation signal 490, but may alternatively take place for any other suitable amount of time, for example for one quarter or one eighth of the period of the light source modulation signal 490. As will be understood by the skilled person, if the plurality of secondary arrays 910 are of a single ended pixel type, the pixels may be controlled to accumulate charge for this part/interval of the period and not accumulate any charge for the remainder of the period. If on the other hand they are of a differential pixel type, the pixels may be controlled to accumulate charge for this part/interval of the period on one side of the pixel and accumulate charge on the other side of the pixel for the remainder of the period.

During the read-out period of time 1020₁, controller 430 may control the light source 410 to cease emitting light and readout from the plurality of secondary arrays 910 image sensor values that are indicative of the charge accumulated in the imaging pixels of each internal feedback array 920-950. The nature of the readout values will depend on the technology of the internal feedback arrays 920-950. For example, if they comprise CMOS sensors, voltage values may be readout, where each voltage value is dependent on the charge accumulated in an imaging pixel, such that the readout voltage values are each indicative of charge accumulated in imaging pixels of the plurality of secondary arrays 910. In other sensor technologies, the nature of the readout values may be different, for example charge may be directly readout, or current, etc. For example, the plurality of secondary arrays 910 may be controlled to readout image sensor values row-by-row using any standard readout process and circuitry well understood by the skilled person. In this way, a sample of charge accumulated by each imaging pixel during the accumulation period 1010₁ may be read off the plurality of secondary arrays 910, converted to a digital value and then stored by the controller 430. The group of values, or data points, arrived at the conclusion of this process is referred to in this disclosure as a charge sample, such that at the end of readout period 1020₁, the controller 430 will have obtained a plurality of charge samples, one for each of the plurality of secondary arrays 910.

It will be appreciated that the accumulation period of time 1010₁ may last for multiple periods/cycles of the first modulation signal (as can be seen in FIG. 10) in order to accumulate sufficient light at the plurality of secondary arrays 910 to perform an accurate determination of the phase of the received internal feedback light 480 relative to the modulation signal 490, for the interval of each internal feedback array 920-950 during the first accumulation period 1010₁. This accumulation period of the multiple arrays may occur at the same time as the main array or a separate time to the main array. Additionally, the integration period may be repeated multiple times over multiple frames of operation with multiple measurements made and filtering performed on those measurements in the digital domain to reduce noise.

During the second accumulation period of time 1010₂, the controller 430 controls the first source 410 to output light modulated by the modulation signal 490 for an accumulation period of time 1010₂. This is very similar to the accumulation period 1010₁, except during accumulation period of time 1010₂ the accumulation control signal output by the controller 430 to the plurality of secondary arrays 910 (i.e., the demodulation signal) is of a different phase relative to the modulation signal 490. In this particular example, it is 90° out of phase with the modulation signal 490 such that each of the internal feedback arrays 920-950 accumulate charge for a different part/interval of the period/cycle of the modulation signal 490 (90°-270°, 105°-285°, 120°-300°, 135°-315°, respectively, as can be seen in FIG. 10). The read-out period 10202 is very similar to period 1020₁, except the obtained charge samples relate to a shifted or delayed interval of 90°-270°, 105°-285°, 120°-300°, 135°-315° of the modulation signal 490, for each of the first 920, second 930, third 940 and fourth 950 internal feedback arrays respectively.

Third accumulation period of time 1010₃ is very similar to the period 1010₂, except the accumulation control signal output by the controller 430 is again of a different phase relative to the modulation signal 490. In this particular example, it is 180° out of phase relative to the modulation signal 490 such that each of the internal feedback arrays 920-950 accumulate charge for a different part/interval of the period/cycle of the modulation signal 490 (180°-360°, 195°-15°, 210°-30° or 225°-45°, respectively, as can be seen in FIG. 10). The read-out period 1020₃ is very similar to period 1020₂, except the obtained charge samples relate to a shifted or delayed interval of 180°-360°, 195°-15°, 210°-30°, 225°-45° of the modulation signal 490, for each of the first 920, second 930, third 940 and fourth 950 internal feedback arrays respectively.

Finally, fourth accumulation period of time 1010₄ is very similar to the period 1010₃, except the accumulation control signal output by the controller 430 is again of a different phase relative to the modulation signal 490. In this particular example, it is 270° out of phase relative to the modulation signal 490 such that each of the internal feedback arrays 920-950 accumulate charge for a different part/interval of the period/cycle of the modulation signal 490 (270°-90°, 285°-105°, 300°-120°, 315°-135°, respectively, as can be seen in FIG. 10). The read-out period 1020₄ is very similar to period 1020₃, except the obtained charge samples relate to a shifted or delayed interval 270°-90°, 285°-105°, 300°-120°, 315°-135° of the modulation signal 490, for each of the first 920, second 930, third 940 and fourth 950 internal feedback arrays respectively.

It can be seen from the above that for each accumulation period 1010₁-1010₄, the start timing of pixel accumulation timing relative to the light modulation signal 490 is shifted (i.e., the relative phase of the light modulation signal 490 and the pixel demodulation signal, which controls pixel accumulation timing, is shifted) for each of the plurality of secondary arrays 910. In this example, it is achieved by the controller 430 adjusting the relative phase of the accumulation control signal that it outputs to the plurality of secondary arrays 910 for each accumulation period 1010₁-1010₄, with each of the internal feedback arrays 920-950 then applying a different delay to that signal. The light modulation signal 490 is unchanged for each accumulation period 1010₁-1010₄. As noted previously, the controller 430 may instead output a plurality of control signals to control the accumulation periods of the plurality of secondary arrays 910 individually.

However, as an alternative the relative phase of the light modulation signal 490 and the accumulation control signal (e.g., the demodulation signal) may be changed for each accumulation period 1010₁-1010₄ by adjusting the light modulation signal 490 and keeping the accumulation control signal fixed. For example, FIG. 11 shows four accumulation periods 1110₁-1110₄. In each of these accumulation periods, the light modulation signal 490 is delayed relative to the accumulation control signal, such that the phase of the emitted light relative to the accumulation control signal is different during each accumulation period 1110₁-1110₄. As can be seen, each internal feedback array 920-950 applies its own delay to the charge accumulation signal, as explained earlier. As a result, during each accumulation period, each of the plurality of secondary arrays 910 will accumulate charge during over a different interval of the light modulation signal 490. Consequently, just as with the example of FIG. 10, at the conclusion of the final readout period 1120₄, 16 different charge samples will have been obtained, each representing charge accumulated during a different interval of the light modulation signal 490. Whilst in this example, 16 different charge samples are arrived at, it will be appreciated that the total number will depend on the number of internal feedback arrays in the plurality of secondary arrays 910 and the number of accumulation periods. Consequently, FIGS. 10 and 11 both show techniques for controlling the system 900 to accumulate charge at the plurality of secondary arrays 910 at various different intervals of the light modulation signal 490.

Whilst in these examples each accumulation period 1010₁-1010₄ lasts for 50% of the period of the laser modulation signal (i.e., for 180°), in an alternative each accumulation period may be shorter, for example 60°, or 90°, or 120°, etc, with the start of each accumulation period for one of the image sensors relatively offset by 90° as explained above. Each of the image sensors may have an offset accumulation period relative to one another other.

After completing the four accumulation periods 1010₁-1010₄, 16 samples of data (charge samples) have been acquired and stored in memory, four samples from each of the internal feedback arrays 920-950. They together may be referred to as a first set of charge samples. Immediately after the read-out period 1020₄, or at some later time, a phase relationship between the light emitted from the light source 410 and the internally fed-back light 480 may be determined using the 16 charge samples (for example by performing a discrete Fourier transform (DFT) on the samples to find the real and imaginary parts of the fundamental frequency, and then determining the phase from the real and imaginary parts, as will be well understood by the skilled person). There is noise associated with each measurement, however the more pixels that are inside each array the greater the reduction in noise can be. Further, many repeated measurements can be made with the same array to also reduce noise.

This measured phase relationship may be compared to an expected/ideal phase relationship for the internally fed-back light 480 (e.g., the phase relationship that would be expected for the distance the internally fed-back light 480 travels, if there were no offset or cyclic errors). In some instances, the internal optical feedback path between the light source 410 and the plurality of secondary arrays 910 is so small that, given the speed of light, the expected phase relationship may be that the light arriving at the plurality of secondary arrays 910 is perfectly in phase with the light emitted from the light source 410. By comparing the measured phase relationship with the expected/ideal phase relationship, offset and cyclic errors of the system may be determined.

FIG. 12 represents the expected/ideal 302 phase relationship and measured, actual phase relationship 304 (including offset and cyclic error) of the ToF system 900. Points 1202, 1204, 1206 and 1208 represent the samples measured by each of the plurality of secondary arrays 910 during the first accumulation period 1010₁. It is clear that taking a greater number of samples allows the offset and cyclic errors of the system to be seen with greater accuracy. If only a single secondary array imaging sensor were used instead of the plurality of secondary image sensors 910, only point 1102 would be sampled for the first accumulation period 1010₁. Consequently, without any speed/time penalty, by including a plurality of secondary arrays 910 the cyclic and offset errors of the ToF system 900 may be determined more accurately. This in turn means that the errors may then be more effectively reduced or compensated for, which in turn improves the accuracy of depth/distance determination performed by the ToF system 900.

Whilst in this example the plurality of secondary arrays 910 includes four imaging sensors, it is clear that it may comprise any number for example, 2, 3, 4, 5, 6, 7, 8, 10, 12, 16, 24, 32 etc. Further, whilst four accumulation periods are shown in FIGS. 10 and 11, any other number of accumulation periods may alternatively be used, for example 2, 3, 4, 5, 6, 7, 8, 10, 12, 16, 24, 32 etc. The greater the number of arrays with different phase shifts with respect to the light source modulation, the higher the order of the cyclic error that can be calculated. Further, the more arrays that are available with less integration periods 1010 the faster the cyclic error can be acquired.

FIGS. 11a and 12a show the operation of system similar to that of FIGS. 11 and 12. However, in the cases of FIGS. 11a and 12a, the plurality of secondary image arrays 910 of FIG. 9 is in fact a two-tap differential pixel which includes 4 sub-arrays. Further, the system is operated with only three accumulation periods 1110₁-1110₃.

A two-tap demodulating pixel is a pixel that accumulates charge in each of its respective taps. The demodulating pixel is supplied with two control signals (for example control signal phase-a and control signal phase-b). During a high period of control signal phase-a (or however the control signal represents that accumulation should take place), the pixel will accumulate charge on the first tap. During a high period of control signal phase-b, the pixel will accumulate charge on the second tap.

FIG. 11a shows sensor-charge accumulation relating to the first tap of each of the pixels, accumulating charge over, for example, the phase 0 degrees-180 degrees. The two-tap pixel would also accumulate charge on the second tap of each of the pixels for the remainder of the phase range, for example, in the range 180 degrees-360 degrees.

It should be noted that whilst FIGS. 11a and 12a are presented in relation to a two-tap demodulating pixel, pixels with higher number of taps, such as four-tap pixels, eight-tap pixels, may be used. A four-tap pixel would have four control signals, with each control signal controlling the accumulation of charge over a different 90 degrees of the 360 degrees of the demodulating frequency being used.

The scheme shown here means that as the different light phases are used versus the primary array the plurality of secondary arrays builds up a total of 12 points from 0/180deg to 165/345 degrees, 4 points at a time, and in the any period 1110x there are 4 points available to use that span the 180/360 degrees. Each of the secondary arrays are spaced equally in time by delays equivalent to 45degs. They do not need to be spaced equally as long as how much they are spaced is understood to the required tolerance, this could for example be measured and accounted for at test.

A calculation of offset can be done with just one illumination, and a better calculation of offset and a build-up of cyclic error can be done with the illuminations that would normally be used for the light source versus the primary array so no adjustment of the multiple secondary array phases versus the light source is needed to be able to perform any extraction of offset or cyclic error of this fixed path and use that to modify the light source relative delay and/or its shape, or to be used in any subsequent calibration or correction of depth measured by the primary array.

By accumulating charge over three periods 1110₁-1110₃ the system may arrive at a determination of cyclic error faster than the system of FIGS. 11 and 12, which accumulate charge over four periods 1110₁-1110₄.

FIGS. 11b and 12b shows an alternative spacing of the delays for the four secondary arrays, this time each is phased (or configured to accumulate charge) by 15 degrees relative to each other, with the same characteristic that these delays do not need to be adjusted, and that after the 3 phases of the light relative to the primary and fixed multiple secondary arrays it will be possible to extract the offset and cyclic errors either to be used in modification of the light source relative delay and/or its shape, or to be used in any subsequent calibration or correction of depth measured by the primary array.

Note if the distance of the optical path from the light source to the plurality of secondary arrays is different this may also be accounted for in the calculation of offset or cyclic error.

Many other schemes with multiple secondary arrays are possible.

The use of multiple secondary arrays to determine at least one of the offset or cyclic error may allow the ToF system to be calibrated or corrected to reduce the impact of the offset or cyclic error. Once offset or cyclic error has been determined, ToF distance measurements performed using the main image sensor may be calibrated or corrected to remove the errors. For example, the controller may be configured to use the determined error of the ToF system to modify the light outputted by the light source to reduce the error of ToF system. This would reduce the error in future distance measurements performed using the ToF system.

Alternatively, the system may correct the depth map or distance measurement performed using the main image sensor after the depth map or distance measurement has been performed. For example, the controller may be configured to correct the ToF distance measurement digitally using the determined offset and cyclic error. For example, the phase relationship shown in FIG. 11, 12a or 12b may be included in a look-up-table stored in local memory, showing the relationship between detected phase and the ideal/actual phase relationship which should have occurred. The system may then correct measurements performed using the ToF system using this look-up-table. Alternatively, a processor may determine the relationship between detected and ideal phase and formulate an equation representing this relationship. The system may then correct measurements performed using the ToF system using this equation.

Correction/Reduction of Offset and/or Cyclic Errors

The offset and cyclic errors present in the ToF system may be determined in any number of ways, as described above. For example, one or a plurality of secondary arrays may be used to accumulate charge from incident light which travels down an internal optical feedback path of a known length, and the phase of the detected light compared to a theoretical phase shift which should occur over the known path. Alternatively, the main, or primary image sensor may be used in conjunction with an optical switch. Once the magnitude of the offset and cyclic errors are determined using any of the previously described methods and systems, a calibration may be applied to the ToF system to remove or reduce the effects of the error.

In some situations, the error may be reduced or removed performing post-processing determination of the depth frame using data readout from the main array 420. For example, FIG. 13 shows a ToF system 1300 including an imager or main image sensor 420 and a secondary image sensor 470. The main image sensor 420 and secondary image sensor 470 may perform the operations described previously with respect to FIGS. 4-12. For example, the secondary image sensor 470 may include one or a plurality of image sensors. Whilst a secondary image sensor 470 is shown in this example, the offset and cyclic errors may alternatively be determined using only the main image sensor 420, for example as described with respect to FIG. 8.

During operation of the system 1300, the main array 420 may accumulate charge in a number of accumulation periods, as described earlier with reference to FIG. 2. The depth processor 1310 may then readout the charge samples from the main array 420 and determine a distance calculation (i.e., determine a depth frame). A calculation may be performed by the phase calculation unit 1320 to determine the phase of the light received by the main image sensor 420 relative to the light modulation signal. Charge accumulated by the secondary image sensor 470 may be used by the error detection unit 1330 to determine the offset and/or cyclic error of the system 1300, using any of the previously described processes. Post-processing calibration may be applied by the error correction unit 1340 to the phase calculations determined by the phase calculation unit 1320. Phase unwrapping 1350 may then be performed on the corrected phase calculations in order to determine the distance to the imaged object (i.e., determine the depth frame A point cloud, or depth frame, may be generated by the point cloud generation unit 1360 to provide a map of the measured distances. The point cloud, or depth/distance frame, may be provided 1370 to external applications or third-party devices for use.

The inventors have recognised that correcting the offset and/or cyclic errors by post-processing may increase the computational intensity of determining the depth frame. To address this, the inventors have developed techniques for modifying the light modulation signal used to drive the light source 410 in order to reduce or remove the cyclic and/or offset errors.

FIG. 14 shows an example ToF system 1400 including a depth processor 1310, which operates in a similar manner to the ToF system 1300. However, unlike the system of FIG. 13, the errors determined by the error detection unit 1330 are reduced or removed by modifying the modulation signal that is used to modulate the light emitted from the light source 410.

Error detection is by error detection unit 1330 using charge accumulated on the secondary image sensor 470, as explained earlier. However, rather than using the determined error to correct the output of the phase calculation unit 1320, the system may instead modify the modulated signal used to control the light source 110. There are various different ways of modifying the modulation signal, any one or more of which may be used.

FIG. 14 shows the controller 430 comprising a modulation signal generator 1410, which outputs the modulation signal used to modulate light emitted from the light source 410. The modulation signal generator 1410 may comprise any suitable circuits and components for generating the modulation signal, for example a clock generation circuit as described earlier with reference to FIG. 1. The error detection unit 1330 may be configured to pre-distort the modulation signal by outputting control signal 1415 to the modulation signal generator 1410. The control signal 1415 may comprise an indication of the determined offset and/or cyclic error, which the modulation signal generator 1410 may use to determine how to pre-distort the modulation signal. Alternatively, the error detection unit 1330 may be configured to determine how the modulation signal generator 1410 should pre-distort the modulation signal and the control signal 1415 may comprise control signals to effect that pre-distortion.

The modulation signal generator 1410 may pre-distort the modulation signal in order to change the shape of the signal. Changing the shape of the signal should change the harmonic content of the signal. The harmonic content of the signal contributes to the cyclic errors of the ToF system, so the modulation signal is pre-distorted in order to change its harmonic content in a way that reduces or removes the cyclic errors.

Pre-distortion may be performed by the modulation signal generator 1410 in one or more different ways. For example, predistortion may be applied such that a different predistortion is applied to different frequencies of the modulation signal, as the harmonic signature varies with frequency. The pre-distortion can also modify the effective delay of the fundamental of the light if required. In one example, it may change the duty cycle of the modulation signal. For example, modulation signal may be a square way signal having a 50:50 duty cycle, meaning that the signal is ‘high’ for 50% of the signal period and is ‘low’ for the other 50% of the signal period. The modulation signal may be predistorted by changing that duty cycle, for example to 60:40. Additionally or alternatively, the modulation signal generator 1410 may change the shape of the modulation signal in any other suitable way, for example modifying the amplitude of the modulation signal, introducing additional amplitude levels to the signal so that it more closely replicates a sine wave signal, or more closely replicates a signal such that after the laser driver and through the laser the light contains less of the harmonics, changing the magnitude different amplitude levels and/or duration spent at each amplitude level for a multi-level signal, etc. Although we show the modulation signal generator making the change, depending on the partition and capability of the components it is also possible to do it elsewhere, for example additionally or alternatively the system may communicate to the laser driver which may contain a means to alter the pre-emphasis of the drive or may contain a DAC and a PLL and be able to create multiple levels within one period to alter the shape as requested.

Additionally or alternatively, the modulation signal generator may change the modulation signal partway through the accumulation periods 210₁-210₄, 230₁-230₄ (which are described earlier with reference to FIG. 2).

ToF systems may operate at multiple frequencies. For example, a continuous wave ToF system may operate at a first frequency, then at a second frequency, comparing the phase relationships at these different frequencies so as to perform phase unwrapping. Due to the nature of harmonics, at least one of the cyclic and offset errors may be different at these different frequencies. As such, the system may operate to determine the cyclic and offset error at a first frequency, then determine the cyclic and offset error at a second frequency. The system may then apply different error corrections depending on whether the ToF system is operating at the first frequency of the second frequency. Whilst frequency correction is described here with respect to two frequencies, the system may operate in a similar manner to correct more than two frequencies, for example, three, four, or six frequencies.

FIG. 15 shows an example a representation of such a scheme, where there are two different signals with different duty cycles, but the same frequency. Signal 1 has a duty cycle of 1:2 (Low:high), which means that for ⅓ of the period of the signal, the signal is low and for ⅔ of the period of the signal, the signal is high. Signal 2 is the same frequency as signal 1, but has a duty cycle of 2:1 (low:high), such that for ⅔ of the period of the signal, the signal is low and for ⅓ of the period of the signal, the signal is high. Because of the integrating nature of the main array 420 during an accumulation period, if the modulation signal generator 1410 outputs signal 1 as the modulation signal for a first part of the accumulation period (for example, the first half) and then outputs signal 2 as the modulation signal for a second part of the accumulation period (for example, the second half), this effectively combining the two signals, the result of which is represented in FIG. 15.

The combination of the two signals in this example may approximate/synthesise a sine signal having the same fundamental frequency as signal 1 and signal 2. As can be seen, the combined signal approximates/synthesises a sine signal by oscillating between two energy levels (e.g., between two extreme energy levels, or max and min) and at least one intermediate energy level (e.g., between the two extreme energy levels), such that the combined signal is closer in nature to a sinusoidal signal compared with the two square wave signals Signal 1 and Signal 2. As a result, by combining two different square wave signals in this way, a sinusoidal illumination signal may be approximated such that the amplitude of at least some of the harmonic content in the combined signal is lower than the amplitude of the corresponding harmonic content in the first and second signals. This may reduce or remove the cyclic errors of the system. The charge accumulation timing described earlier with reference to FIG. 2 may be controlled using a 1:1 duty cycle square wave signal at the same frequency as signal 1, signal 2 and the combined signal, with appropriate timing alignment relative to signals 1 and 2 to achieve the desired charge accumulation timing. That control signal is sometimes referred to earlier as the ‘demodulation’ signal. Whilst in this example two signals are combined to approximate/synthesise the sine signal, it will be appreciated that any number of signals with appropriate duty cycles may be combined to approximate/synthesise a sine signal. Typically, the larger the number of signals that are being combined, the more closely the combined signal may approximate a sine signal, but the more complex the signal generation and control may be. Therefore, the number of signals that are used may be chosen based on the requirements of the ToF camera system. The control signals may not be square waves, but rather any signal which has a fundamental component at a fundamental frequency and one or more harmonic components at one or more harmonic frequencies.

The harmonic content of the combined signal may be adjusted by changing the amount of time each of signals 1 and 2 are used as the modulation signal; and/or by changing the duty cycle of one or more of signal 1 and signal 2; and/or by changing the amplitude of one or more of signal 1 and signal 2. Therefore, pre-distorting the modulation signal in this way may be used to reduce or remove the cyclic errors of the system. Whilst in this example each different signal consecutively, one at a time, during the accumulation period, in an alternative the modulation signal generator 1410 may be configured to generate and combine the two or more signals itself, so that the modulation signal output to the delay unit 1420 is the combined signal.

In the above, various different examples are disclosed for how the modulation signal generator 1410 may pre-distort the modulation signal in order to reduce or remove system errors determined by the error detection unit 1330. Additionally or alternatively, the modulation signal may be pre-distorted by adjusting at least one setting of the driver 1430. The light source driver 1430 is configured to receive the modulation signal and generate a drive signal based on the modulation signal (for example, the drive signal may be an amplified version of the modulation signal), the drive signal being used to drive the light source 410 to emit light. As will be well known to the skilled person, such light source drivers 1430 typically have one or more adjustable settings that define how the light source driver 1430 responds to the received modulation signal, for example how it responds to the rising and falling edges of a square wave signal. For example, the adjustable settings may comprise one or more of: a sag compensation setting; an over/under shoot setting; or to synthesize a arbitrary waveform for example by having a DAC that uses a clock locked to the incoming signal to generate adjustable steps at a higher frequency. The laser driver could also have one or more of its analog characteristics altered, for example any filtering or resonance could be adjusted. Adjusting one or more or these settings should change the shape of the drive signal output in response to the modulation control signal, which should change the harmonic content of the light emitted from the light source 410, which should in turn change the cyclic error of the system. The signal 1435 output by the error detection unit 1330 may comprise the one or more driver settings, which the error detection 1330 may determine based on the measured system errors in order to reduce the system errors. Alternatively, the signal 1435 may comprise the measured system errors, which the driver 1430 may use to determine the adjustment to the one or more driver settings in order to reduce the system errors.

In a further example represented in FIG. 14, the modulation signal may be modified by including a delay unit 1420 that applies an adjustable time delay to the modulation signal. The delay unit 1420 may comprise any suitable circuitry to adjustably delay the progress of the modulation signal to the light source 410. This effectively adjusted the timing of the modulation signal relative to the charge accumulation signal (the demodulation signal) used to control the main array 420. Whilst the delay unit 1420 is represented as a separate unit/circuit within FIG. 14, it may alternatively be part of the driver 1430 or part of the modulation signal generator 1410. Applying a time delay to the modulation signal may reduce or eliminate the offset error of the ToF system 1400, and potentially also reduce or eliminate the cyclic errors of the system. The signal 1425 output by the error detection unit 1330 may comprise a delay setting used to control the delay applied by the driver 1420, which the error detection unit 1330 may determine based on the measured system errors. Alternatively, the signal 1435 may comprise the measured system errors, which the driver 1430 may use to determine the adjustment to the time delay in order to reduce the system errors. It should be noted that the delay that is added may be to achieve a target delay that is being accounted for in the processing signal chain. For example, the target delay might be 2nS, the measured delay may be 1.67 ns and a delay of 0.33 ns may be added to achieve the overall delay.

Whilst FIG. 14 shows a system where the modulation signal is modified in numerous different ways, it will be appreciated that the system may be configured such that the modulation signal is modified in only one of the disclosed ways, or is modified in any two or more of the disclosed ways.

Each of the disclosed modifications to the modulation signal may be performed in a number of different ways. For example, the required modification may be calculated based on the determined ToF system errors, or it may be looked up in memory where suitable modifications for different levels of system error may be stored (which may have previously been determined, for example, experimentally). Additionally or alternatively. The modifications may be performed in an iterative manner. For example, a modification may be made and the offset and/or cyclic error may be measured. The modification may then be iteratively changed and the offset and/or cyclic error remeasured until the error has reduce to an acceptable level or been eliminated entirely. The delay and modulation modifications may be different for all the frequencies being used in the system, but the system may use information from one to adjust the starting point for the other, as some characteristics may be translatable.

Also, while the system could be driving down the measurement of cyclic error to minimise it based on the number of points of phase that have been measured, and the harmonics being measured it may by taking into account a model of the light emission path and be able to drive down harmonic content in higher harmonics using that model. For example, a model of the light emission chain could be characterised to a higher number of sampling points over a number of different units, and a machine learnt model created that takes in the lower number of measured points in a given unit but predicts a correction that covers higher order errors with an improved probability based on the learnt relationship.

The skilled person will readily appreciate that various alterations or modifications may be made to the above described aspects of the disclosure without departing from the scope of the disclosure.

What is claimed is:

1. A time-of-flight (ToF) imaging system, the ToF system comprising:
a light source for outputting modulated light;
a main image sensor;
a plurality of secondary image sensors;
an internal optical path of a known distance for carrying part of the modulated light emitted from the light source to each of the plurality of secondary image sensors; and
a controller configured to determine, based on charge accumulated by the plurality of secondary image sensors, an error of the ToF system, wherein the error comprises at least one of a cyclic error and an offset error.

2. The ToF system according to claim 1, wherein the controller is configured to control the light source to emit the modulated light for a first amount of time using a first laser modulation signal.

3. The ToF system according to claim 2, wherein the controller is configured to control the charge accumulation of the plurality of secondary image sensors during the first amount of time such that each image sensor of the plurality of secondary image sensors is configured to accumulate charge over a different phase range of the first laser modulation signal.

4. The ToF system according to claim 2, wherein the controller is configured to control the light source to emit light for a second amount of time using a second laser modulation signal.

5. The ToF system according to claim 4, wherein the second laser modulation signal is a delayed version of the first laser modulation signal.

6. The ToF system according to claim 4, wherein the second laser modulation signal is the same as the first laser modulation signal.

7. The ToF system according to claim 4, wherein the controller is configured to control the charge accumulation of the plurality of secondary image sensors during the second amount of time such that each image sensor of the plurality of secondary image sensors is configured to accumulate charge over a different phase range of the second laser modulation signal.

8. The ToF system according to claim 1, wherein the controller is configured to determine a phase relationship between modulated light emitted by the light source and light received by the plurality of secondary image sensors.

9. The ToF system according to claim 8, wherein the controller is configured to determine the error of the ToF system by comparing the determined phase relationship with a theoretical phase relationship based on the known distance of the internal optical path.

10. The ToF system according to claim 1, wherein the plurality of secondary image sensors comprises four image sensors.

11. The ToF system according to claim 1, wherein the controller is configured to perform a ToF distance measurement by detecting light incident on the main image sensor.

12. The ToF system according to claim 11, wherein the controller is configured to correct the ToF measurement using the determined error of the ToF system to reduce the error of the ToF system.

13. The ToF system according to claim 11, wherein the controller is configured to use the determined error of the ToF system to modify the light outputted from the light source to reduce the error of the ToF system.

14. A method of determining distance using a time of flight (ToF) system, the method comprising:
emitting modulated light using a light source;
detecting the emitted light at a main image sensor;
detecting the emitted light at a plurality of secondary image sensors located a known distance from the light source;
determining at least one of an offset and a cyclic error of the ToF system based on charge accumulated by the plurality of secondary image sensors.

15. The method according to claim 14, the method further comprising:
controlling charge accumulation of the plurality of secondary image sensors during a first time period such that each image sensor of the plurality of secondary image sensors is configured to accumulate charge over a phase range of the emitted light different from that of other image sensors of the plurality of secondary image sensors.

16. The method according to claim 15, the method further comprising:
controlling charge accumulation of the plurality of image sensors during a second time period such that each image sensor of the plurality of images sensors is configured to accumulate charge over a phase range of the emitted light different to that of the other image sensors of the plurality of secondary image sensors and different to the phase range during the first time period.

17. The method according to claim 14, wherein determining at least one of an offset and cyclic error comprises:
determining a phase relationship between the emitted modulated light and light received by the plurality of secondary image sensors; and
comparing a determined phase relationship with a theoretical phase relationship based on the known distance.

18. The method according to claim 14, wherein the method further comprises:
applying a calibration to the ToF system based on the determined at least one of offset and cyclic error.

19. The method according to claim 14, the method further comprising:
determining a ToF distance measurement based on the light detected at the main image sensor.

20. A time-of-flight (ToF) imaging system, the ToF system comprising:
a light source configured to emit light;
a plurality of secondary image sensors;
an optical path of a known distance between the light source and the plurality of secondary image sensors, arranged such that part of the emitted light is carried by the optical path to the plurality of secondary image sensors; and
a controller configured to:
control the plurality of secondary image sensors, such that each image sensor of the plurality of secondary image sensors accumulates charge over a different phase range of the emitted light; and
determine at least one of a phase error and an offset error, using charge accumulated by each of the plurality of secondary image sensors.
